(19) United States
(12) Patent Application Publication
(10) Pub. No.: US 2005/0187858 A1
(43) Pub. Date: Aug. 25, 2005

(54) Fixed income security offerings management techniques and related applications

(76) Inventors: Russell J. Graham, Wheaton, IL (US); David A. Rieger, Warrenville, IL (US); Matthew R. Treter, Naperville, IL (US); Jonathan J. Volle, Wheaton, IL (US)

Correspondence Address: MCANDREWS HELD & MALLOY, LTD, 500 WEST MADISON STREET, SUITE 3400, CHICAGO, IL, 60661, US

(21) Appl. No.: 11/065,240

(22) Filed: Feb. 23, 2005

Related U.S. Application Data
(60) Provisional application No. 60/547,146, filed on Feb. 23, 2004.

(51) Int. Cl. G06F 17/60

(52) U.S. Cl. 705/37

(57) ABSTRACT

Disclosed is an electronic fixed income securities management and trading system and method for aggregating customer demand for investment securities, especially fixed income securities, and identifying suitable offered securities to meet that demand. This system and method enables the collection, organization, and integration of securities demand information from multiple sources, and provides techniques to identify which securities among those available for sale have sets of characteristics that satisfy the demand criteria, preferably with a menu driven system.

### RELATED APPLICATIONS

Priority is claimed from provisional patent application U.S. Ser. No. 60/547,146, filed Feb. 23, 2004, now pending. The entire specification and all the claims of the provisional application referred to above are hereby incorporated by reference to provide continuity of disclosure.

### BACKGROUND OF THE INVENTION

This invention relates to a system and method for aggregating customer demand for investment securities, especially fixed income securities, and identifying suitable offered securities to meet that demand. This system and method enables the collection, organization, and integration of securities demand information from multiple sources, and provides techniques to identify which securities among those available for sale have sets of characteristics that satisfy the demand criteria, preferably with a menu driven system.

Bonds, notes, and debt instruments issued by government entities and corporations to raise capital are known as fixed income securities. They typically have a fixed rate of interest payment, a set redemption value, and a specified date of maturity. They vary widely in terms of their credit quality, structure, and price sensitivity to interest rate environment changes. Buyers and sellers in the fixed income securities market, such as broker/dealers, deal with many challenges that are absent from the more familiar equity markets and exchanges. For the vast majority of fixed income securities, there is no centralized market or exchange. Instead, trading is done on what is known as an over-the-counter basis, with buyers and sellers indicating inquiries and offerings, and typically negotiating the price for each trade, the telephone being the primary tool used to execute transactions. Therefore, the traditional approach to buying and selling fixed income securities such as municipal bonds, U.S. government agency bonds, and corporate bonds is inefficient.

Unlike the equity exchanges and networks, where a buyer or seller can generally find a liquid market with current bid and ask prices for a given security, a buyer in the fixed income market may not be able to find a specific security offered for sale, and a seller in the fixed income market may not be able to find a buyer looking for a security of a given type. Fixed income securities offered in the market need to be individually evaluated, as the number of unique securities is very large. The price of a security may be dependent on the quantity traded, motivating some market participants to consider combining trades for multiple accounts to obtain best price execution. These factors result in unique challenges to efficient securities trading within the fixed income market.

Bond traders at broker/dealers manage inventories of fixed income securities and are responsible for making buy and sell decisions to maximize the profitability of the trading, while serving customers well by offering appropriate securities for sale. Their inventories must also comply with prescribed inventory size, composition, and liquidity goals and constraints. Many factors create challenges to successful inventory management, such as market dynamics that impact the value of current inventory holdings, adjustments to the prescribed guidelines on inventory composition and goals, difficulty in locating appropriate securities in the market, and challenges of marketing current inventory to customers.

Due to the nature of the fixed income securities market, the transaction quantity may have significant impact on price and availability of a security, and managers of security inventories may often need to consider the impact of a sale on the marketability of the remaining balance of a security held in inventory. Holding fixed income investment security inventory has associated costs of capital, and subjects the broker/dealer to market risk and/or hedging expense. Furthermore, customer demand profiles may be continually changing to reflect changes in their investment objectives, or resulting from the impact of their buying activity. Therefore, in order to determine and execute the best inventory management decisions, what is needed is a means to quickly determine the current demand profiles of multiple bond-buying customers, and the changes in the marketability of inventory that would result from various possible inventory changes.

The market has changed in recent years; technology now allows dealers and customers to interact through electronic media. One of the greatest factors contributing to the increased popularity of electronic trading has been the phenomenal growth of the Internet, allowing connectivity among nearly all market participants.

The popularity of electronic systems has resulted in a dilemma for market participants. There are numerous trading and trading support systems for the fixed income market, overwhelming both buyers and sellers with too many technology choices. As a result, there is a need for software applications that can provide a centralized marketplace for buying and selling fixed income securities, that can support the buy/sell process, and that can serve as an intermediary between buyers and sellers to facilitate the distribution of fixed income securities.

Various solutions currently exist for the analysis of inventories of fixed income securities. These include software applications and information services that allow the computation and display of various measures of aggregate portfolio characteristics, the graphical display thereof, and analysis of the before-and-after results of purchases and sales. Various sophisticated forms of quantitative analysis and statistical techniques of risk management are also in use, often using back-testing of strategies based on historical market data to attempt to identify promising trading strategies for current market conditions.

There is a need for a product that can create an efficient electronic environment that supports market participants' existing processes and emulates their current business practices, for example, that emulates the over-the-counter fixed income market.

The benefit that this invention uniquely provides is the aggregation of detailed buyer-specific investment security demand, the ability of sellers to quickly match their inventory of investment security offerings with the aggregated demand, and the ability to efficiently communicate the matched offering information to the corresponding buyer to facilitate the efficient management of fixed income investment security inventories.

### BRIEF SUMMARY OF THE INVENTION

The system and method of the present invention combines security offerings management and offerings dissemination tools with access to, and interaction with aggregated demand information collected from multiple buy-side market participants. Furthermore, the present invention provides tools that connect broker/dealers to buyers and sellers in the securities markets, especially in the fixed income securities markets, such as bond markets. The integration of inventory management and marketing tools, aggregated demand information, and bond market access creates a more efficient way to buy and sell fixed income securities. Therefore, a fixed income securities management and trading system in accordance with one embodiment of the present invention may integrate features including securities offering management, securities trading and securities demand information management.

One object of the present invention is to increase trading efficiencies by facilitating the communication between buy-side and sell-side market participants.

Another object of the present invention is to provide an interface to the fixed income marketplace by enabling a broker/dealer user to interact with indications of demand for fixed income securities from buy-side market participants, wherein the interface can allow the user to match his inventory to the demand.

A further object of the present invention is to allow broker/dealer users to electronically communicate to specific buy-side market participants information about one or more of his security offerings that match the requirements as specified in the buy-side users description of his demand. For example, if the buy-side user is using a compatible software application, the broker/dealer can cause a buy-side user to be alerted to the availability of a matching offering, and communicate the specifics of the matching offering in an electronic format that the buy-side user can interact with, through use of his compatible software application.

Still another object of the present invention is to allow broker/dealer users to set any number of offerings access controls which allow him to define exactly which market participants receive information access to which of his specific offerings.

Still a further object of the present invention is to provide a means for broker/dealer users to receive feedback from receivers of their offering information that indicates whether a buy-side user has viewed, downloaded, matched with investment security demand, or deleted offering information for specific offered securities.

In one aspect, the present invention provides a method for users of a fixed income securities management and trading system employing a computer system and a computer communication network to manage securities, for example, inventories of fixed income securities. The method of this aspect of the present invention includes steps of:
(1) entering into the computer system characteristics of one or more fixed income securities offerings or buyer-sought fixed income securities by a first user, and
(2) enabling the first user to control access to the characteristics of the one or more fixed income securities offerings or buyer-sought fixed income securities by a second user via the computer communication network; wherein the access control comprises allowing the second user to view or preventing the second user from viewing the entered characteristics.

In another aspect, the present invention provides a method of matching seller offerings to buyer demand, trading negotiation, directing offerings, and/or giving offerings feedback with respect to securities, especially fixed income securities, by buyers and sellers using a securities management and trading system employing a computer system and a computer communication network. The method includes the steps of:
(1) entering into the computer system characteristics of buyer-sought securities sought by one or more buyers;
(2) enabling at least one of the sellers to view the characteristics of at least one of the buyer-sought securities via the computer communication network;
(3) entering into the computer system characteristics of seller-offered securities offered for sale by one or more sellers;
(4) matching some or all of the characteristics of some or all of the buyer-sought securities with the corresponding characteristics of some or all of the seller-offered securities by using the computer system to identify seller-offered securities matching buyer-sought securities;
(5) enabling at least one of the sellers of the matching seller-offered securities to direct one or more of the matching seller-offered securities to the attention of at least one of the buyers seeking the buyer-sought securities having the matched characteristics via the computer communication network; and
(6) enabling the at least one buyer seeking the buyer-sought securities having the matched characteristics to view the characteristics of the directed one or more matching seller-offered securities via the computer communication network.

In a further aspect, the present invention provides a method of managing trading by buyers and sellers using a fixed income securities management and trading system that enables a buyer and a seller to negotiate trades. The method includes the steps of:
(1) entering into the computer system characteristics of seller-offered securities offered for sale by at least one seller;
(2) enabling at least one buyer to view the characteristics of the seller-offered securities via the computer communication network; and
(3) enabling an electronic messaging dialog between the at least one buyer and the at least one seller about the seller-offered securities via the computer communication network.

In still another aspect, the present invention provides a method of managing fixed income securities by users of a securities management and trading system employing a computer system and a computer communication network that can quantify buyer demand. The method of this aspect includes the steps of:
(1) entering into the computer system characteristics of buyer-sought fixed income securities sought by a buyer or characteristics of fixed income securities previously purchased by the buyer;
(2) enabling a seller to select from a plurality of formats for viewing the entered characteristics via the computer communication network; and
(3) enabling the seller to view the entered characteristics in the selected format via the computer communication network.

In yet another aspect, the present invention provides a method of managing trading in relation to new issuance by buyers and sellers using a fixed income securities management and trading system employing a computer system and a computer communication network. The method of this aspect includes the steps of:
(1) entering into the computer system characteristics of new issuance fixed income securities offered for sale by a seller; and
(2) enabling the seller to direct one or more of the new issuance securities to the attention of at least one of the buyers via the computer communication network.

In still a further aspect, the present invention provides a method of managing trading in relation to sessions by buyers and sellers using a fixed income securities management and trading system employing a computer system and a computer communication network. The method of this aspect includes the steps of:
(1) providing a seller with access to characteristics of a fixed income security owned by a first buyer for marketing of the fixed income security by the seller;
(2) entering into the computer system sale terms for the fixed income security owned by the first buyer for the marketing of the fixed income security by the seller;
(2) enabling the seller to add the fixed income security to the seller's offerings;
(3) enabling the seller to direct a description of the fixed income security and sale terms to the attention of at least one second buyer via the computer communication network; and
(4) enabling the at least one second buyer to view the description of the fixed income security and the sale terms via the computer communication network.

The method steps of the present invention are either incorporated into or can be carried out by one or more computer executable software applications installed in the computer system of the fixed income securities management and trading system of the present invention. The one or more computer executable software applications of the fixed income securities management and trading system of the present invention can further enable the user to analyze historical investment security purchase activity of buy-side users of the securities management and trading system.

The one or more computer executable software applications used in the fixed income securities management and trading system of the present invention can further enable the user to propose, negotiate or execute a purchase or sale of a fixed income security.

### BRIEF DESCRIPTION OF SEVERAL VIEWS OF THE DRAWINGS

FIG. 1A is a schematic block diagram illustrating an Internet web-based computer system showing one embodiment of the invention.

FIG. 1B is a schematic block diagram illustrating an exemplary personal computer system of the type used in the computer systems shown in FIG. 1A.

FIGS. 2-32 are screen displays illustrating various embodiments of the invention.

### DETAILED DESCRIPTION OF THE INVENTION

The following detailed description illustrates the present invention by way of example, not by way of limitation, of the principles of the invention. This description describes several embodiments, adaptations, variations, alternatives and uses of the invention, including what are presently believed to be the best modes of carrying out the invention. This description will clearly enable one skilled in the art to make and use the invention.

Some general terms that will be used throughout this specification are explained below.
Buyer: A market participant and system user who purchases investment securities for the benefit of its firm or its firm's clients.
Seller: A market participant and system user who sells investment securities for the benefit of its firm or its firm's clients.
Broker/Dealers (B/Ds): Sell-side market participants and system users who manage investment securities inventories and are responsible for making transaction decisions to maximize their firm's trading profitability while supporting their customer's transaction needs. Sometimes they are referred to as “traders” in this specification.
Non-Broker/Dealers (Non B/Ds): Buy-side market participants using components of the securities management and trading system who manage investment securities for the benefit of their clients. Typically these system users are firms like trust departments, money management firms, and mutual funds, which may have many widely located offices, and that typically consolidate their buying and selling of fixed income securities at a single location.
Offering: A sell-side user's indication of the terms under which he is willing to sell an investment security. An offering may include, for example, a CUSIP, par amount, quantity restrictions (multiples of, minimum block size), settle date, and offering dollar price and/or yield. System offerings can exist with various statuses that control how other market participants view and interact with them. Offering statuses are discussed in greater detail below.
Directed Offering: An offering sent by a sell-side user to one or more buy-side users in the system for their evaluation. Directed Offerings are formatted to be directly downloaded into the buyer's compatible software application.
Inquiry: Description entered by a buy-side user of specific number of sought blocks of specific par amounts of securities with specific required or prohibited characteristics.
New Issuance: Securities offered to the public for the first time.
Securities Demand Information: Characteristics of buyer-sought fixed income securities and description of total quantities and/or quantity increments thereof.

Traders of inventories of fixed income securities for broker/dealers (i.e., traders) have recognized that there is a need for systems, means, computer software applications, and methods to efficiently analyze buyer demand and communicate security offerings to appropriate buy-side market participants.

The present invention relates to a method and a system for managing and marketing inventories of investment securities offered for sale, for example, fixed income securities such as municipal bonds. The method and system of the present invention can provide great flexibility in the managing and marketing process.

In the following description, for the purposes of explanation, numerous specific details are set forth in order to provide a thorough understanding of the present invention. It will be apparent, however, to one skilled in the art that the present invention may be practiced without some of these specific details.

The present invention includes various steps which will be described below. At least some of the steps of the present invention may be embodied in machine-executable instructions. The instructions can be used to cause a general-purpose or special-purpose processor that is programmed with the instructions to perform the steps of the present invention. Alternatively, at least some steps of the present invention may be performed by specific hardware components that contain hardwired logic for performing the steps, or by any combination of programmed computer components and custom hardware components.

While, embodiments of the present invention will be described with reference to a Marketplace Managers^{SM} (“MMan”) software tool developed by BondWave LLC (Lisle, Ill.), the method and system described herein are equally applicable to other types of investment security inventory management and marketing software applications, involving different kinds of securities.

### System Overview

The present invention may be included within a client-server based electronic securities management and trading system, which can perform securities offering management, securities trading and securities demand information management.

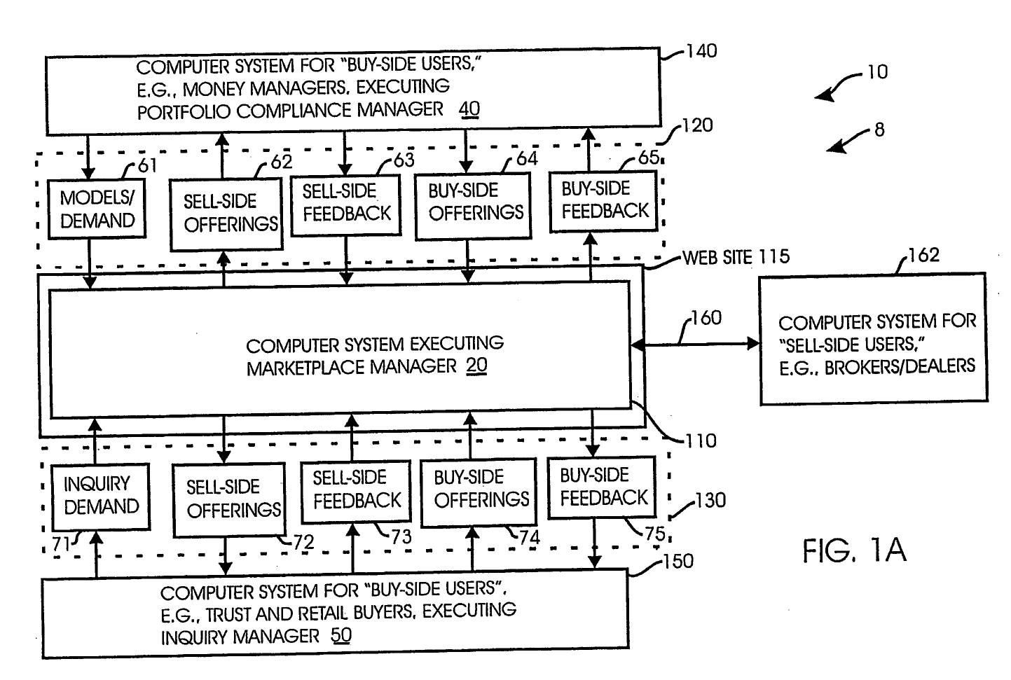

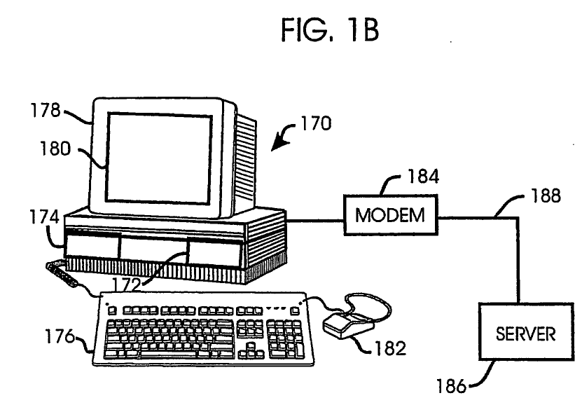

As shown in FIG. 1A, a securities marketplace management software application 20 (e.g., MMan) is integrated with other software applications utilized by a variety of different users at various firms and locations that, in combination, make up the electronic securities management and trading system 8 implemented on a computer system 10. Each part of the electronic securities management and trading system 8 serves to facilitate the communications between buy-side and sell-side securities market participants, such as investment managers and securities broker/dealers.

By way of illustration, buy-side users are typically institutional securities investors such as trust departments, find managers, and investment managers of individual clients' accounts, who are responsible for buying and selling securities for those accounts. Sell-side users are typically broker/dealers that maintain an inventory of investment securities, such as bonds, which they market to the buy-side market participants. Both buy-side and sell-side users or market participants use the electronic securities management and trading system 8.

FIG. 1A illustrates that computer system 10 of the electronic securities management and trading system 8 can include various computer subsystems 110, 140, 150 and 162. FIG. 1A also illustrates examples of the various types of information that can be exchanged between users of system 8 through the use of computer system 10. The marketplace management software application 20 preferably is executed on computer subsystem 110, which includes, preferably, a web server (or web servers) (not shown) addressable at a web site 115 on the Internet or other computer communication networks. Each buy-side user sends data to and receives data from the web-based management software application 20 over an Internet connection, such as Internet connection 120 or 130, from computer subsystem 140 that is executing a portfolio compliance software application 40, such as the software application described in U.S. patent application Ser. No. 10/934,976 filed Sep. 3, 2004 (available under the trademark Portfolio Compliance Manager® (“PCMan”) from BondWave, LLC), and incorporated by reference in its entirety in this application; or from computer subsystem 150 that is executing an inquiry management software application 50, such as the software program described in U.S. patent application Ser. No. 09/752,490, filed Dec. 28, 2000 (available under the trademark Inquiry Manager® (“InqMan”) from BondWave, LLC), and incorporated by reference in its entirety in this application. Computer subsystem 140 or 150 can include a personal computer used by a user of the electronic securities management and trading system 8.

Application 40 (e.g., PCMan) is designed for use by a first type of buy-side users, such as an institutional money manager, and application 50 (e.g., InqMan) is designed for use by a second type of buy-side users, such as a buyer for trust departments or an institutional buyer for individual retail accounts. Buy-side users of applications 40 and 50 can access web site 115 and the web-based software application 20 and database (not shown) hosted on a web server (or web servers) (not shown) by an application service provider (ASP) through conventional web access controls and techniques.

As shown in FIG. 1A, application 20 (e.g., MMan) can exchange with application 40 (e.g., PCMan) data, such as models and/or demand information 61, sell-side offerings 62, sell-side feedback 63, buy-side offerings 64, and buy-side feedback 65. Application 20 (e.g., MMan) can exchange with program 50 (e.g. InqMan) data, such as inquiry demand information 71, sell-side offerings 72, sell-side feedback 73, buy-side offerings 74, and buy-side feedback 75.

Each sell-side user can send data to application 20 and receives data from application 20 over an Internet connection, such as connection 160, from a computer subsystem 162, such as a personal computer, through a conventional web browser.

The information exchanged between sell-side users/participants and application 20 is described in detail in this specification.

FIG. 1B illustrates an exemplary personal computer system of the type that can be used in computer subsystems 140, 150 and 162. The personal computer system is implemented on a personal computer 170 including a central processing unit 172 and a memory 174. Data is entered into the memory by a user via a conventional keyboard 176, by an application program interface (API), or via a network connection to a server computer 186 at a location remote from the location of computer 170. The network connection can include, for example, a modem and/or router 184, a computer communication network 188, such as the Internet, and server computer 186 that stores data in a database (not shown). Memory 174 stores instructions that cause data to be processed and to be displayed as screen displays on a conventional display monitor 178 having a display face 180. The instructions include a plurality of algorithms that enable efficient management of security inquiries, security portfolios and inventories of investment securities for sale. The algorithms may be implemented in a variety of computer languages, such as C#, ASP.NET, or stored procedures within Microsoft SQL Server, with results displayed via conventional web browser or other general user interface without undue experimentation. The entry and manipulation of data is enhanced by use of a conventional computer mouse 182.

Marketplace management software application 20 improves upon the traditional over-the-counter process of trading investment securities, such as bonds and notes. Application 20 is a web-based application that can assist brokers/dealers or other sell-side market participants to manage fixed income security inventories and market the associated holdings to money managers and other types of buy-side market participants. Application 20 provides users with tools to position and manage inventory, to view either aggregate or discrete buy-side historical purchases, to analyze current buy-side demand, to receive electronic feedback on offerings sent to buy-side users, and to interact with other market participants using system 8.

Still referring to FIG. 1A, central features of marketplace management software application 20 and the associated securities management and trading system 8 of the present invention including web-site 115 and database (not shown) can be described as follows.

Management of Owned Offerings

Preferably, application 20 enables sell-side participants in the fixed income investment securities market to manage the offerings they have entered into system 8 from their investment securities inventories. Sellers can enter offerings either manually, or through an Application Program Interface (API). Once the offerings have been entered, the seller can sort, edit, and change the status of the offerings as needed.

Application 20 preferably can provide controls giving sell-side users control over who is allowed to view their offerings, either in their entirety or at the individual offering level. Sell-side users can restrict access for others, such as buy-side firms and other broker/dealers, on both a company and individual user level. System 8 also provides means to allow sell-side users to remain anonymous to buy-side users in trade negotiation.

Ability to Direct Offerings and Receive Offerings Feedback

Preferably, application 20 allows sell-side users to view the buyer demand for fixed income securities entered into system 8. Buyer demand originates from both “inquiry demand” and “portfolio demand” pertaining to buyers using compatible software applications such as applications 40 and 50 in FIG. 1A. Application 20 enables the seller to automatically identify specific current buyer demand that matches one or more of his specific security offerings in system 8. As matches are identified, sell-side users can electronically push or “direct” these offerings to buy-side users, allowing buyers to review them for potential purchase. The buyer is alerted that he has received a directed offering through a pop-up window on his computer system. These directed offerings can be directly imported into the buy-side user's compatible software application, such as application 40 or 50.

Preferably, application 20 provides sell-side users with real-time feedback on the offerings they have directed. As the buy-side users view, evaluate, import or delete the directed offerings that have been sent to them, their actions are recorded for the corresponding sell-side user to review using application 20. Offering feedback is useful to the seller as he makes decisions on the composition of his securities inventory.

Electronic Negotiation Via Messaging

In accordance with one embodiment of the present invention, buy-side users can search for and view the offerings that sellers have entered into system 8. If the buyer is interested in a particular offering, he may initiate an electronic dialogue with the sell-side user for the purpose of negotiating the purchase of some or all of the offered securities. This dialogue may, preferably, include exchanging multiple messages defining the terms of the potential transaction including items such as par amount block size, price, yield, etc.

Enhanced Demand Analysis

Application 20 preferably can provide the display and analysis of real-time demand data collected from buy-side users utilizing other compatible software applications. This demand data can be viewed in several formats, and can be filtered according to the user's preferences. The analysis of current buyer demand is useful to the seller as he makes decisions on the composition of his securities inventory.

New Issuance Integration

Also preferably, application 20 provides the electronic integration of new issue market information for municipal bonds and notes. Through the integration of new issue market information such as that provided through Dalcomp Municipal Wire Systems^{SM} of i-Deal LLC (New York, N.Y.), broker/dealers can automatically load municipal bond new issue scale information into system 8, and distribute the scale details to other market participants using the system 8. Pre-sale scale information (and later, post-sale scale information) can be formatted for direct download into the buyer's compatible software application. After downloading the information, the buyer can then evaluate for purchase any of the bonds and/or notes which make up the new issue scale.

Quantification of Demand Tools

Preferably, application 20 can provide sellers with analysis tools to assist in the management of investment security inventories. Preferably, it gives the sell-side user access to real-time demand data and transaction history, either for a specific investment manager, or in aggregate for multiple buy-side users. Analysis tools enable the sell-side user to filter current demand and past transactions to illustrate an investment manager's purchasing profile. This data can be utilized to try to anticipate the investment manager's future needs and to influence the seller's inventory strategy.

Selective Exposure of Portfolio Holdings & Exclusive Seller Designations (Sessions)

An investment manager will sometimes want to provide a broker/dealer electronic access to his portfolio holdings in order to generate trade ideas. Once electronically granted permission by the investment manager, the broker/dealer can use application 20 to match the investment manager's portfolio holdings to current demand data in system 8 in order to identify potential sell candidates among the holdings. Once the securities have been chosen and the offering terms have been established, the investment manager may then authorize the broker/dealer to exclusively market the securities, thus establishing an exclusive seller designation or “session”.

Application 20 may enable the broker/dealer to automatically provide status updates to the investment manager reflecting any bid or trade activity for the investment securities in the session. Application 20 also may provide the investment manager and broker/dealer a means to re-price the securities to reflect market movements. Fixed income securities are typically priced based on a yield, a measure of the security's value. Yields for fixed income security offerings are often quoted as an interest rate difference, or “spread,” (typically in basis points) from a benchmark yield curve. Since the security's yield and corresponding price are based on a spread from the underlying yield curve, if that underlying yield curve changes, reflecting overall market movement, the security's prices will be automatically adjusted accordingly.

### An Exemplary Marketplace Management Software Application

I. General

Having briefly described the electronic securities management and trading system 8 employing a computer system 10 and the marketplace management software application 20 in accordance with one embodiment of the present invention, the method and system of the present invention will now be described in relation to an exemplary marketplace management software application, i.e., the MMan software tool developed by BondWave LLC (Lisle, Ill.), in which features of the present invention may be implanted in combination with other compatible software applications such as the PCMan and InqMan software tools developed by BondWave LLC (Lisle, Ill.).

As depicted in FIG. 1A, each broker/dealer can access web-based application 20 executed on computer subsystem 110 from a computer subsystem 162 that connects to web site 115 on the Internet or other computer communication networks by use of a conventional web browser. Application 20 and associated system 8 also provides functionality allowing sellers to push or “direct” offerings to buy-side market participants in response to their specific inquiries or demand, and provide electronic feedback on how buyers react to each directed offering.

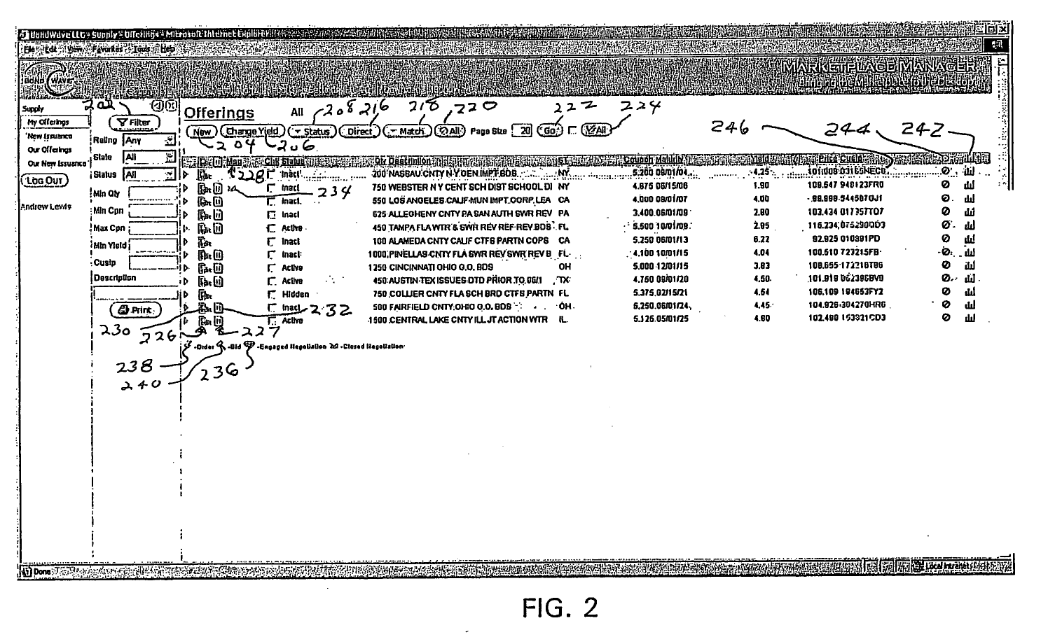

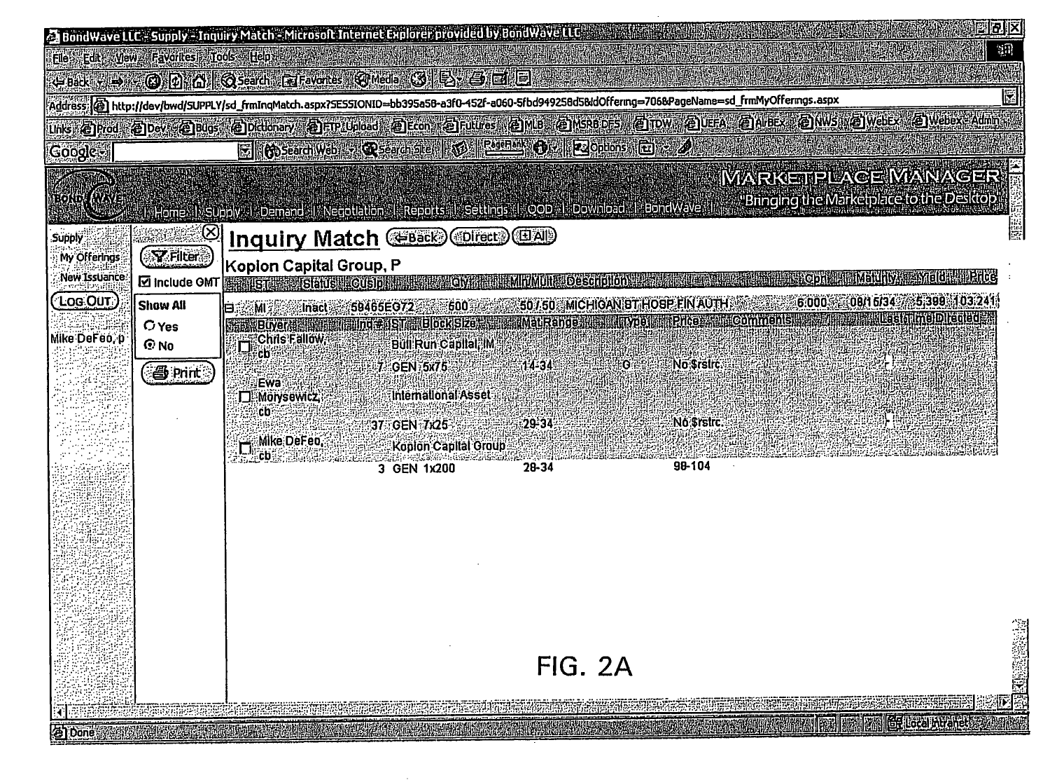

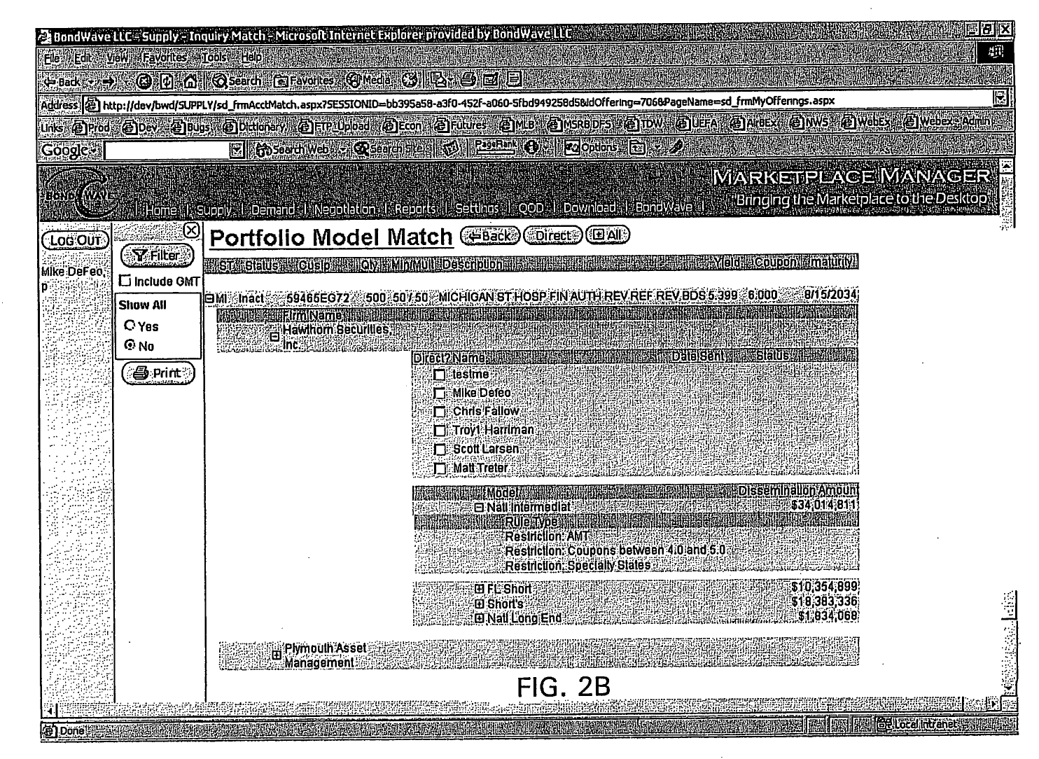

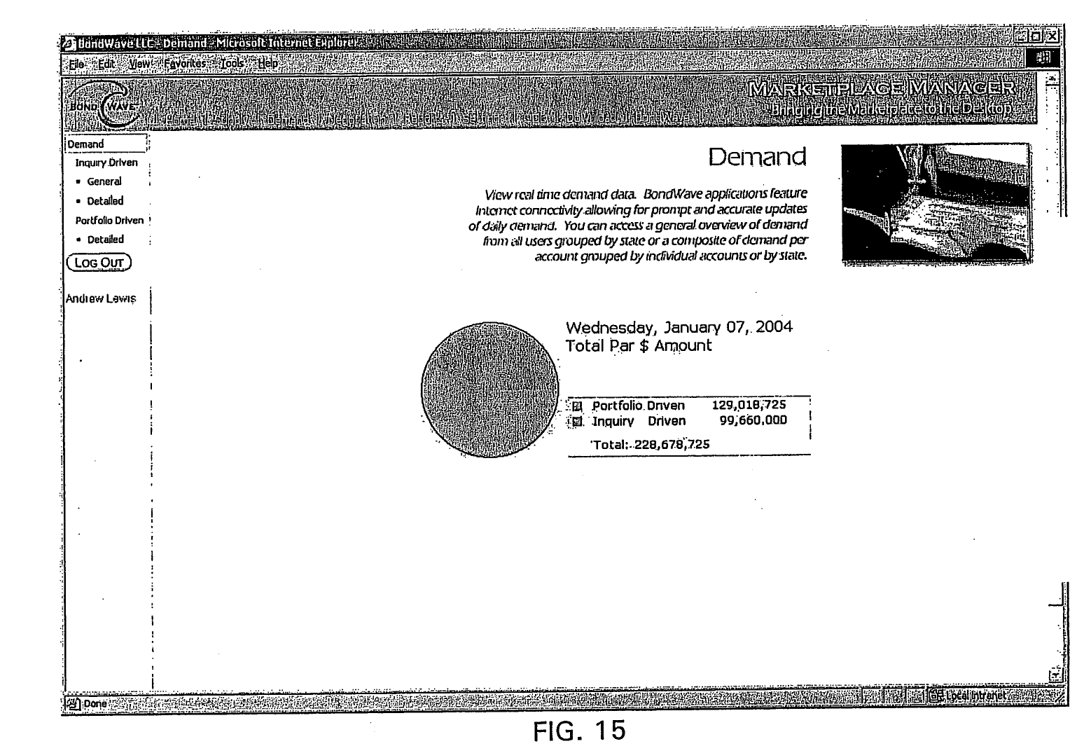

This specification describes each area of application 20 and corresponding portions of system 8. Each top-level section pertains to one of the menu headers that are displayed on the application home page of application 20 at web site 115, an exemplary embodiment of the current invention. Each section describes the functionality contained within that area of the exemplary MMan software application. Screen displays of the exemplary MMan software application are shown in FIGS. 2-32 to explain details of functionality. Based on the screen displays and explanations, those skilled in computer programming can implement the securities marketplace management software application and corresponding portions of the electronic securities management and trading system of the present invention in a variety of computer languages, such as C# and ASP.NET, without undue experimentation.

II. Supply

The Supply section of the exemplary marketplace management software application 20 (e.g., MMan) enables traders to manage their own offerings, view their firm's offerings, and monitor any new issuance that has been uploaded to the securities management and trading system. In order to access the web-based MMan software application hosted by a web-server (not shown) of computer subsystem 110, a user accesses web site 115 by means of a computer remote from web site 115, and enters data from a keyboard by “clicking” on a button shown in a screen displayed by MMan. Clicking is accomplished by depressing a switch of a conventional screen icon selection device, such as a computer mouse.

A. My Offerings

The My Offerings section of MMan as shown in the screen display of FIG. 2 enables a trader to manage the portion of his firm's investment security offerings for which he is responsible. Typically firms have multiple sets of offerings, each of which are individually managed by a securities trader.

The filter pane 202 to the left provides the sell-side user with filter options to help facilitate how his offerings are organized and displayed. Offerings can be filtered and displayed by any of their inherent characteristics such as credit rating, state of issuance, offering status, CUSIP, description keywords, coupon range, etc.

A set of buttons may be provided on the offerings screen display, as shown in FIG. 2, to provide a set of offerings management functions such as those explained below.

1) New

Clicking on the New button 204 of FIG. 2 brings up an Insert Offering screen display as shown in FIG. 3, where the sell-side user will define the investment security to be offered including the terms under which it will be offered. Terms can include CUSIP, par amount, quantity restrictions (multiples of, minimum block size), settle date, and offering dollar price and/or yield. After the offering and its terms have been defined, the sell-side user clicks the Insert button 302, and is returned to the main Offerings screen display of FIG. 2. The newly entered offering will be included in the sell-side user's listed offerings and will appear with the status of New.

2) Change Yield

Clicking on the Change Yield button 206 of FIG. 2 brings up the Yield Change screen display. Here, the sell-side user can enter an amount by which to adjust the offered yield or price for each of the selected offerings on the Offerings screen display of FIG. 2.

3) Status

The Status button 208 of FIG. 2 enables the user to change the status for each of the selected offerings. An offering's status will affect how other system users will view and interact with the offering. Some examples of offering statuses used in the exemplary MMan software application are described below.

a) New—The initial status of an offering upon its entry into the securities management and trading system of the present invention is New. New offerings preferably will not be viewable by other system users, or be included in the results of offerings searches, or be eligible for use in matching to buy-side demand. Sell-side users cannot direct New offerings to buyers. The offering status will remain New until the seller explicitly modifies its status.

b) Active—Offerings with a status of Active preferably are viewable by other system users. Active offerings will be included in the results of offering searches and they can be matched with buy-side demand. Sell-side users can direct Active offerings to buyers. Buy-side users and sell-side users can engage in an electronic dialogue to negotiate a potential transaction of the Active offering.

c) Inactive—Offerings with a status of Inactive preferably are viewable by other system users. Inactive offerings will also be included in the results of offerings searches and they can be matched with buy-side demand. Inactive offerings can be directed to buyers, but they are not eligible for electronic negotiation dialogues.

d) Hidden—Offerings with a status of Hidden preferably are available for viewing only to sell-side users that are part of the same firm as the trader listing the offerings. They are most likely part of his managed inventory, but not currently suitable to be displayed to other system users. Hidden offerings will not appear in the results of offering searches but can be matched with buyer demand. Sellers cannot direct Hidden offerings and they are not eligible for electronic negotiation dialogues.

4) Direct

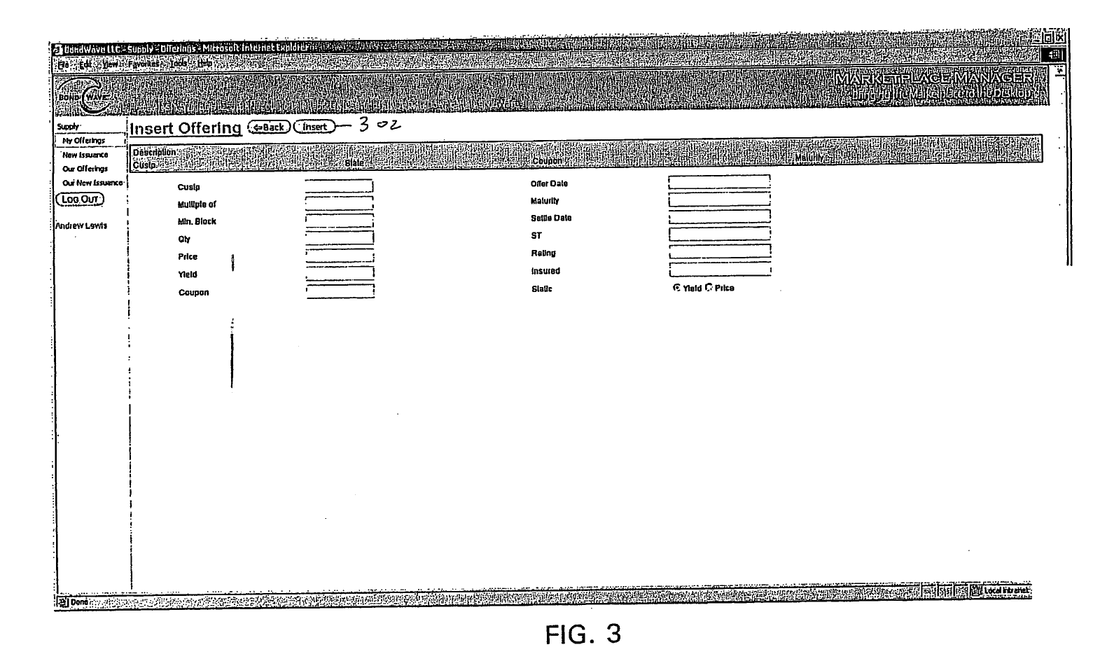

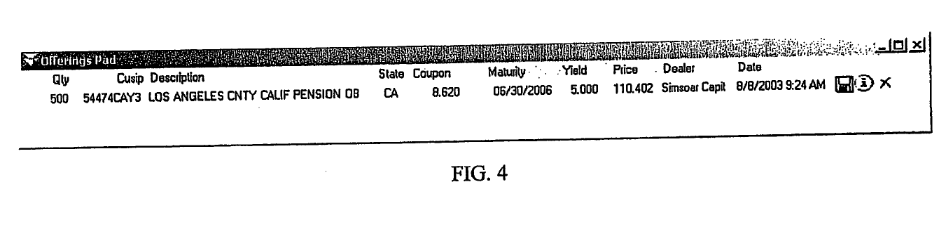

The Direct button 216 of FIG. 2 opens the Direct Offerings screen display which lists all other system users. From here the sell-side user can designate one or more other system users as recipients of his offering. Directing an offering to a specific buy-side user preferably causes a pop-up window to be displayed to the buyer who is using a compatible software application, similar to the screen depicted in FIG. 4. The directed offering is formatted to be downloaded into the buy-side user's compatible software application for his evaluation. Sell-side users can identify which of their offerings to direct to a buyer's attention by using the matching functionality described below.

5) Match

The Match button 218 of FIG. 2 helps the sell-side user identify which of his offerings match the characteristics of any securities sought for purchase by a buyer in the system, with results to be displayed in the Inquiry Match or Portfolio Match screen displays of the exemplary software application MMan as depicted in FIGS. 2A and 2B. The sell-side user clicks the Match button to activate a drop-down menu which includes choices for Inquiry Match or Portfolio Match. As described in greater detail below, these matching algorithms specify which source of buy-side demand the selected offering(s) will be matched against. In this application, “matching” does not only mean what characteristics are required, but also what characteristics are prohibited.

a) Inquiry Match

Choosing the Inquiry Match algorithm will direct the securities management and trading system of the present invention to identify all the specific buy-side user demand that matches the selected offerings. This buy-side demand originates from system users utilizing compatible software applications such as the InqMan software tool developed by BondWave, LLC. The results of the matching will be displayed in the screen display shown in FIG. 2A. From this screen display the sell-side user can choose to direct the offering to the buyer representing the demand information. The matching criteria for the offering and securities sought preferably include characteristics such as maturity date of the offering falling within a specified range, state of issuance of the offering matching the state of issuance or category of states specified, the dollar price of the offered securities falling within a specified range, the amount of the offered securities being sufficient for the specified amount sought, the block-size constraints of the offering being compatible with the specified amount sought, etc.

b) Portfolio Match

Choosing the Portfolio Match algorithm will direct the securities management and trading system of the present invention to identify all the specific buy-side user demand that matches the selected offerings. This buy-side demand originates from compatible software applications such as the PCMan software tool developed by BondWave, LLC. The results of the matching will be displayed in the screen display shown in FIG. 2B. Portfolio Match matching criteria for the match algorithm might include criteria such as state of issuance, maturity range, dollar price, credit rating, credit enhancement, taxability, etc. Those skilled in the art can implement a suitable match algorithm based on the information provided in connection with FIGS. 2, 2A and 2B without undue experimentation.

One important difference between the Inquiry Match and the Portfolio Match in accordance with one embodiment of the present invention is that the Inquiry Match is specific to the increments of block size (par amount), whereas the Portfolio Match, although it may indicate the total par amount required, offers no specifics on the size of the component parts. Unlike some other securities where the price for 10, 25, 50, 100 or 1000 shares is essentially the same, marketability and liquidity for fixed income securities is block size dependent.

6) Ø All

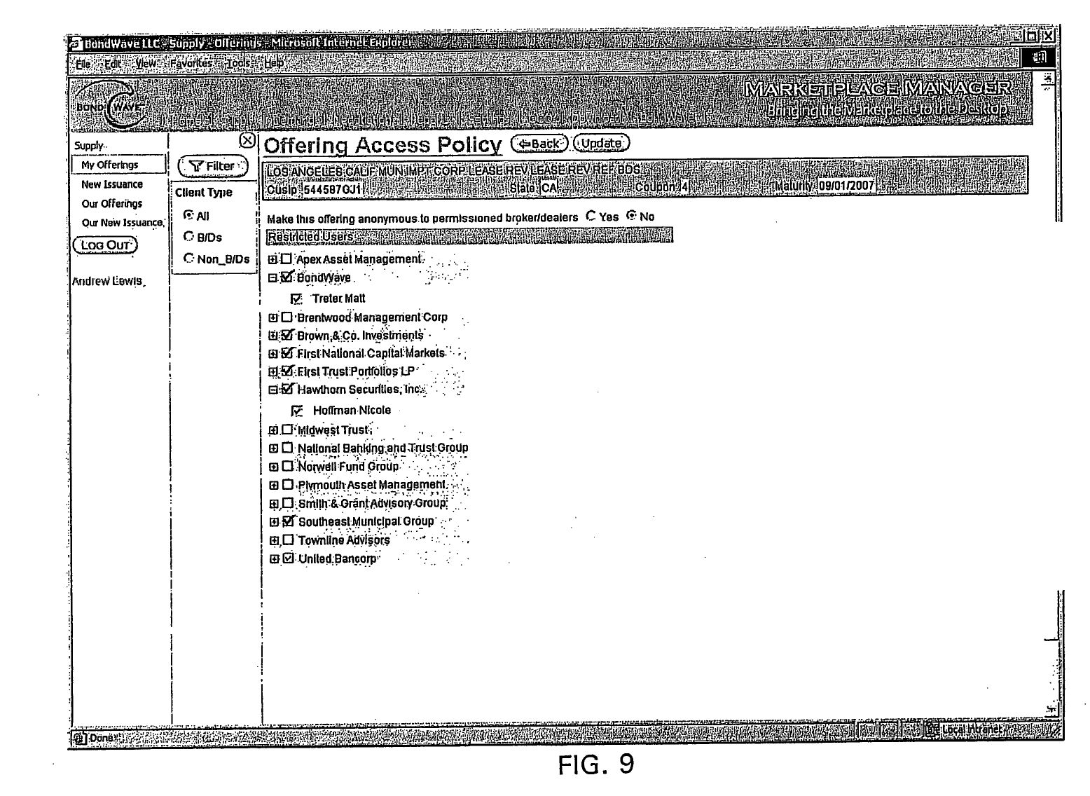

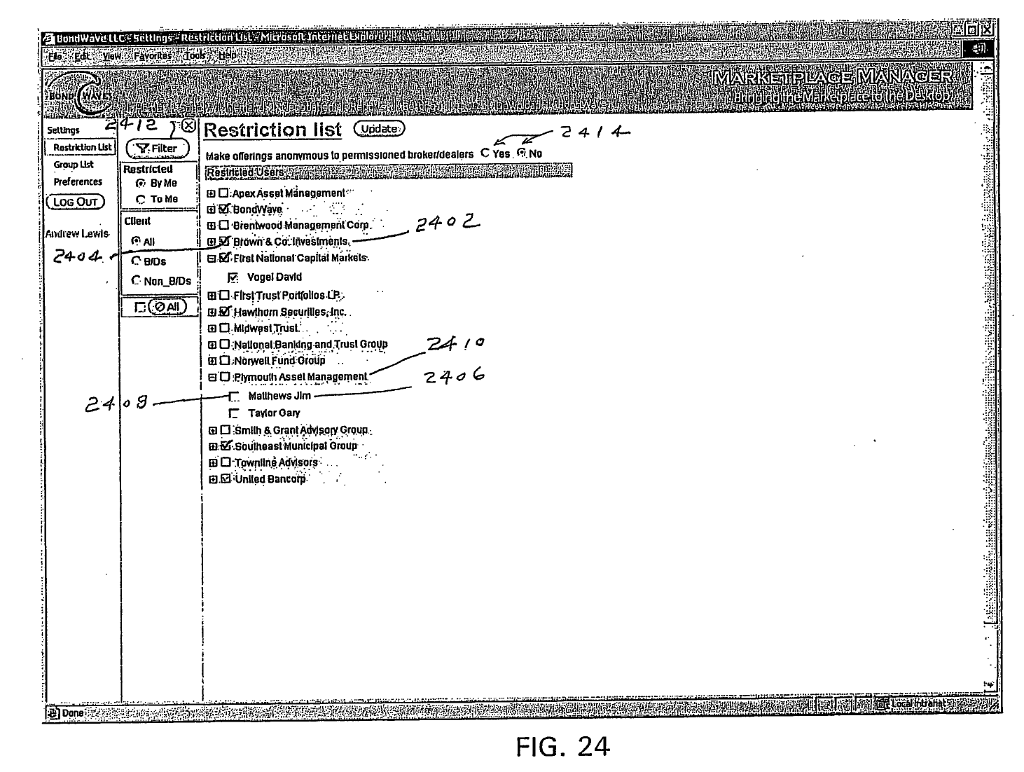

The “Ø All” button 220 of FIG. 2 of the exemplary MMan software application preferably applies the default access restrictions to all the selected offerings. When the default restrictions have been applied to an offering, the 0 symbol associated with that line item can be displayed, for example, in blue. Otherwise, it can be displayed in another color, for example, red. Sell-side users can establish how other system users will view and interact with their offerings on a per-item basis utilizing the Offering Access Policy screen display of FIG. 9 or by establishing default restrictions for all his offerings using the Restriction List screen display shown in FIG. 24.

7) GO

The “Go” button 222 of FIG. 2 preferably can reload the page, displaying the number of lines per page specified in the Page Size text box.

8) √All

The “√Air” button 224 of FIG. 2 will either select or deselect all the sell-side user's offerings, based on whether the checkbox to the left of the √All button is checked or not. This is simply a shortcut method to select or deselect all the offerings at one time instead of one by one.

The Offerings screen display of the exemplary MMan software application as depicted in FIG. 2 further shows some of the key characteristics of each of a sell-side user's investment security offerings. Displayed fields for each offering might include status, offered quantity, short security description, state of security issuance, coupon rate, maturity date, yield, dollar price and CUSIP, for example. In addition, columns to the left of each offering preferably contain icon buttons Edit 226, History 227 and Messages 228, with corresponding functionality as described below.

1) Edit

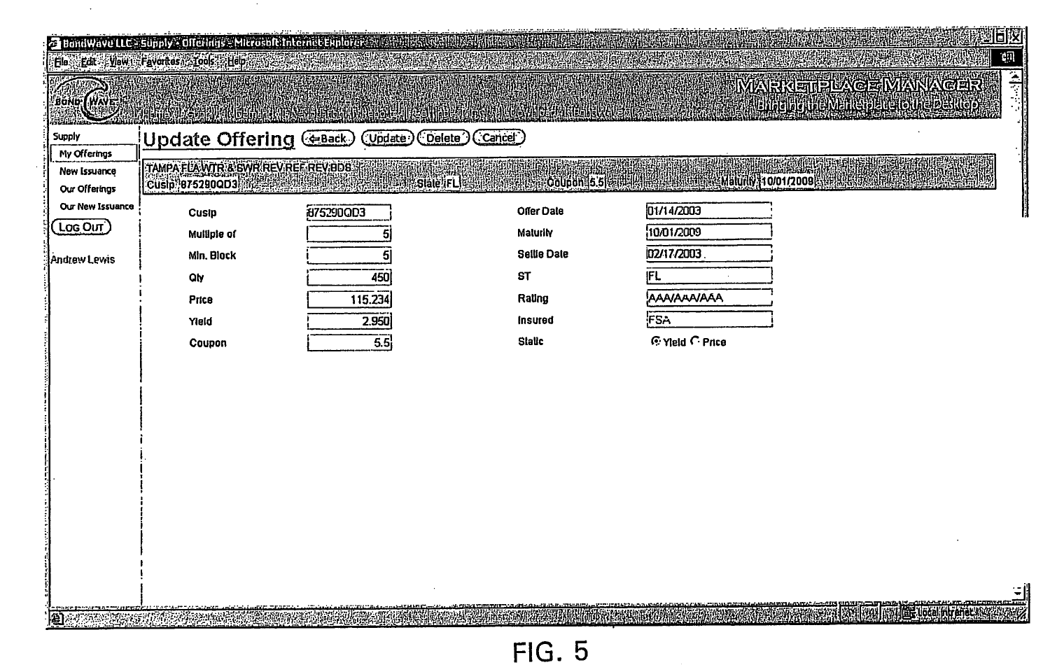

Clicking on an Edit graphic, such as button 230 of FIG. 2, preferably brings up the screen display shown in FIG. 5, where the sell-side user may update or delete the corresponding offering.

2) History

Clicking on an History graphic, such as button 232 of FIG. 2, preferably brings up the screen display shown in FIG. 6, displaying the Direct History for the corresponding offering, including the buyers' Account Feedback.

The Direct History page is divided into two sections, one for the most recent Direct History 602 and the other for the aggregated Account Feedback 604. The Direct History section details which system users 612 have been sent the selected offering. If the status is, for example, the letter “A,” such as item 606, then the buy-side recipient has accessed the directed offering, and some action was performed on it. If the status is, for example, “N,” such as item 608, then the directed offering status remains new, reflecting that it has not been received and/or acted upon.

The second section, Account Feedback 604 preferably shows the total aggregated feedback for each user that the selected offering has been directed to one or more times. The Account Feedback history may include what action the receiving user performed, if any, for each time the offering was directed to them. The recorded feedback actions are described in greater detail below in the Offering Feedback Report section.

3) Message

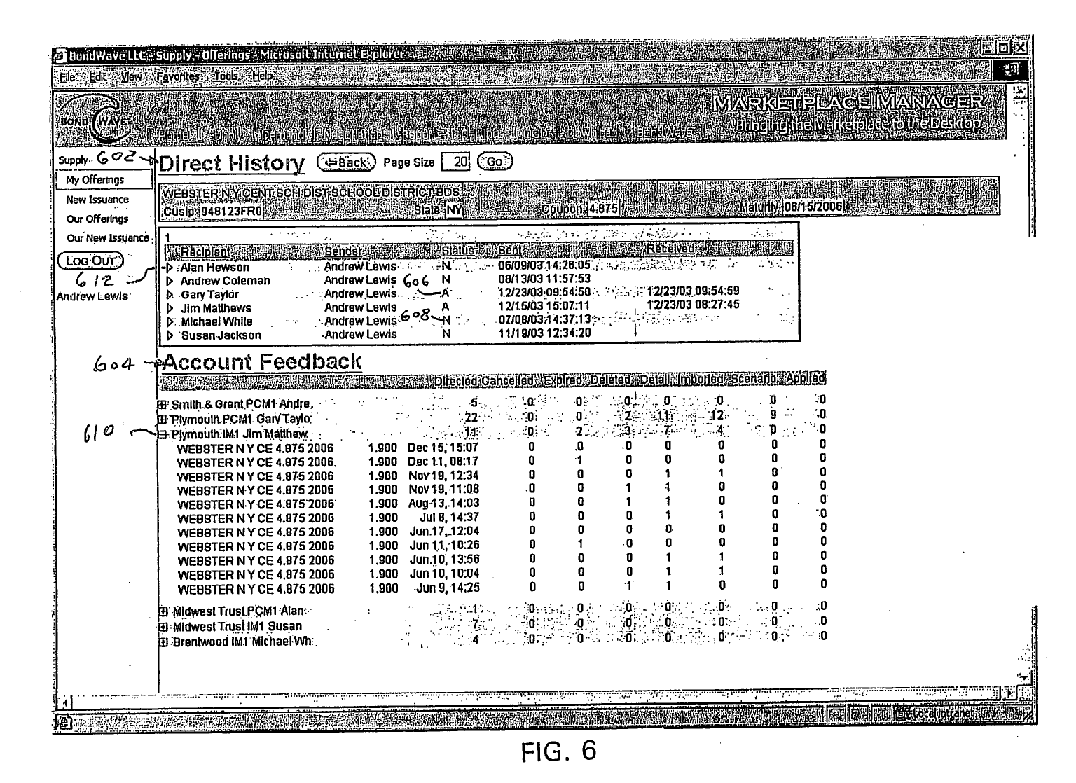

Clicking on a Message button 228 of FIG. 2 preferably indicates the negotiation status of the offering. There may or may not be outstanding orders and bids for the offering. A “closed envelope” icon 234 in the column, for example, may be used to indicate that negotiations were both initiated and closed on the offering. A “diamond” icon 236, for example, may be used to indicate that there are negotiations in progress for the offering. A “lightning bolt” icon 238, for example, may be used to indicate that there are outstanding orders for the offering; and a “gavel” icon 240, for example, may be used to indicate that there are outstanding bids for the offering. Clicking on whichever of these icons that is present preferably will take the user to a screen display such as the Negotiation Items screen display shown in FIG. 7. Displayed here are all the negotiation details for the selected offering.

4) Trade Activity

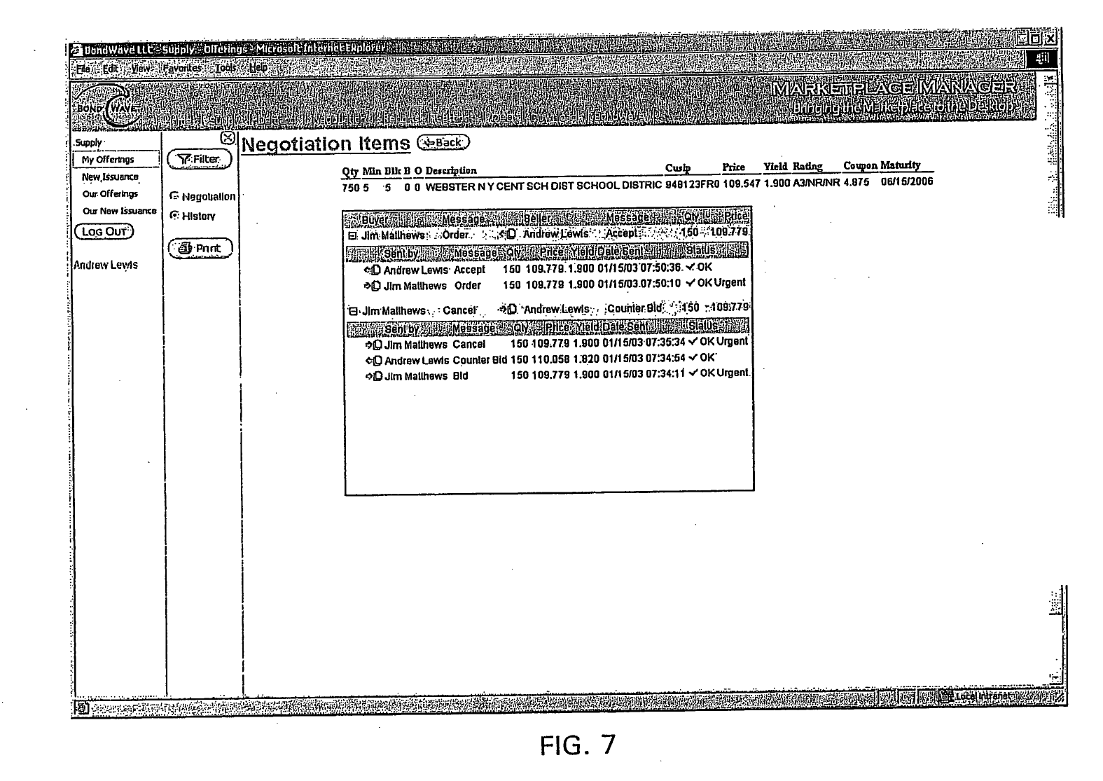

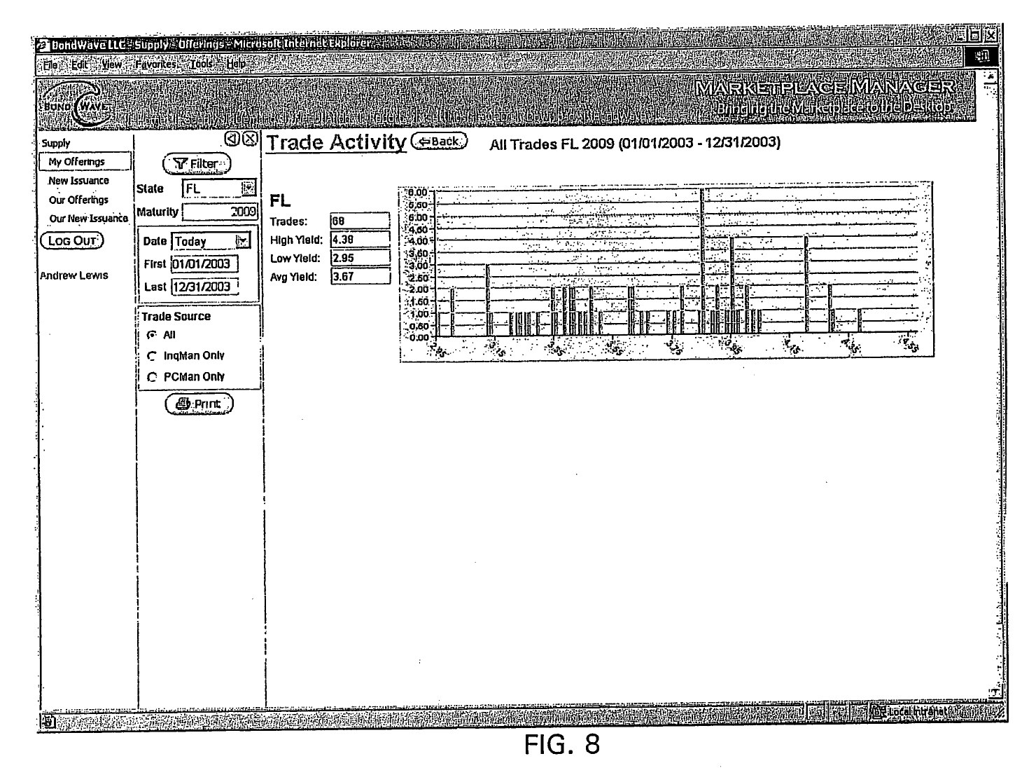

Preferably, to the right of each offering displayed on the Offerings page of the exemplary MMan software application as shown in FIG. 2 is a “bar chart” icon graphic 242, for example. When clicked, the sell-side user may be taken to a Trade Activity screen display as shown in FIG. 8, where trade history information about other investment security trades for securities with similar characteristics to the associated offering, such as state of issuance and maturity year, is displayed. Information about trades for other similar securities is useful in making trading decisions for the selected offering.

5) Offering Access Policy

Preferably, also to the right of each offering displayed on the Offerings page of MMan as shown in FIG. 2 is a “Ø” symbol icon graphic 244. When clicked, the user may be taken to an Offering Access Policy screen display shown in FIG. 9, where he may override the access restrictions for the offering.

For example, by using the screen display shown in FIG. 9, the sell-side user may modify the list of firms that may view this offering as compared to the default restriction access, as set up in the settings area (not shown) of the exemplary software application. Preferably, the sell-side user may also filter this view to show only broker/dealers or only non-broker/dealers. If the access restrictions for an offering are modified, then the “Ø” symbol 234 on the Offerings page as shown in FIG. 2 preferably will be displayed in red, for example, as opposed to displayed in blue for offerings with default access settings.

6) Security Description Detail

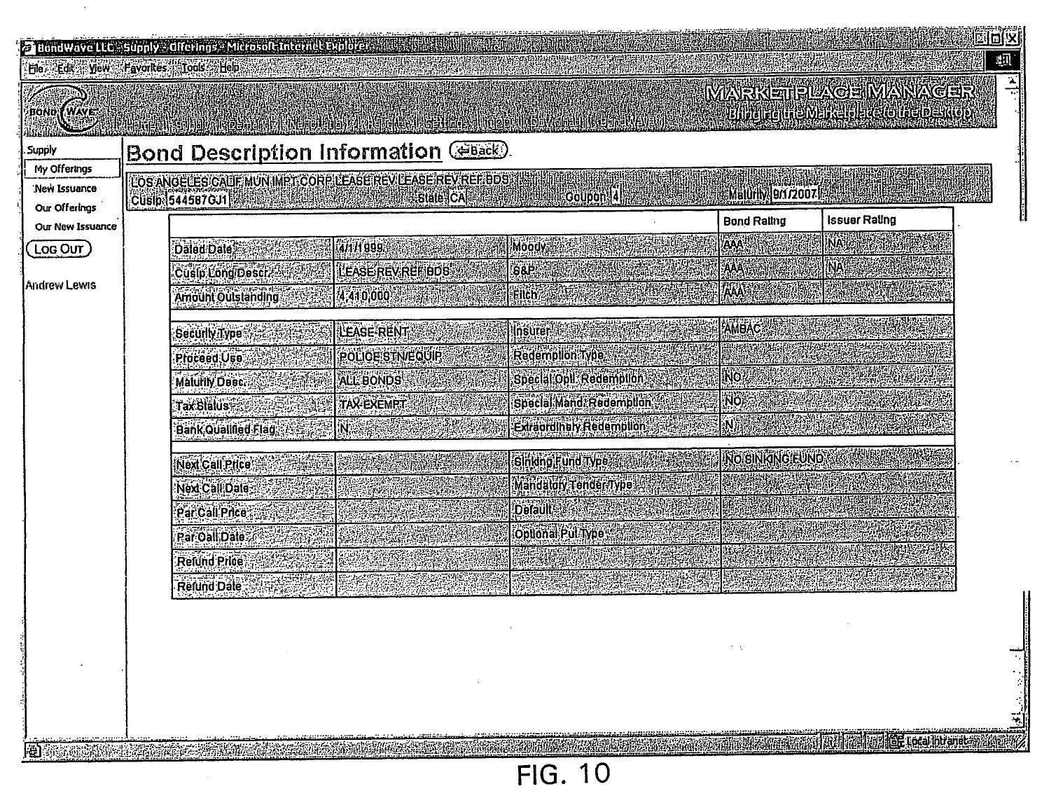

In addition, if the sell-side user clicks on the CUSIP field 246 of an offering displayed on the Offering page of FIG. 2, preferably a new screen display such as the Bond Description Information screen display shown in FIG. 10 is displayed, showing detailed security characteristics corresponding to the selected offering.

B. New Issuance

New issuance refers to both pre-sale and post-award competitive fixed income securities underwriting scale information provided by broker/dealers to buy-side users. Sellers can direct new issuance scale information to buyers similarly to how directed offerings are sent, as described above. Buy-side users are able to search, receive, and view new issuance scale information either directed to them, or posted to the web site of the electronic securities management and trading system of the present invention, such as web site 115 shown in FIG. 1A.

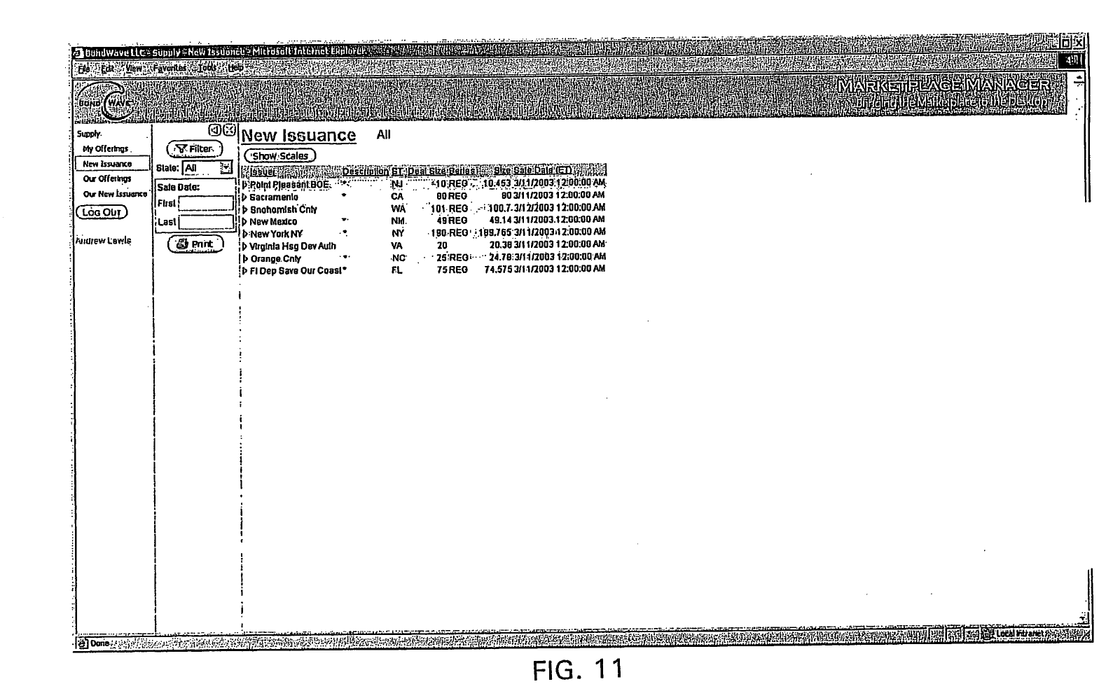

A New Issuance section of an exemplary embodiment of the current invention may provide display of investment security new issuance information as shown in FIG. 11. Broker/dealers preferably may automatically load data pertaining to any new issues into the electronic securities management and trading system of the present invention, and direct the new issues as a group of offerings to potential buyers by using various available new issuance data input programs, such as the Dalcomp Municipal Wire Systems^{SM} of i-Deal LLC (New York, N.Y.).

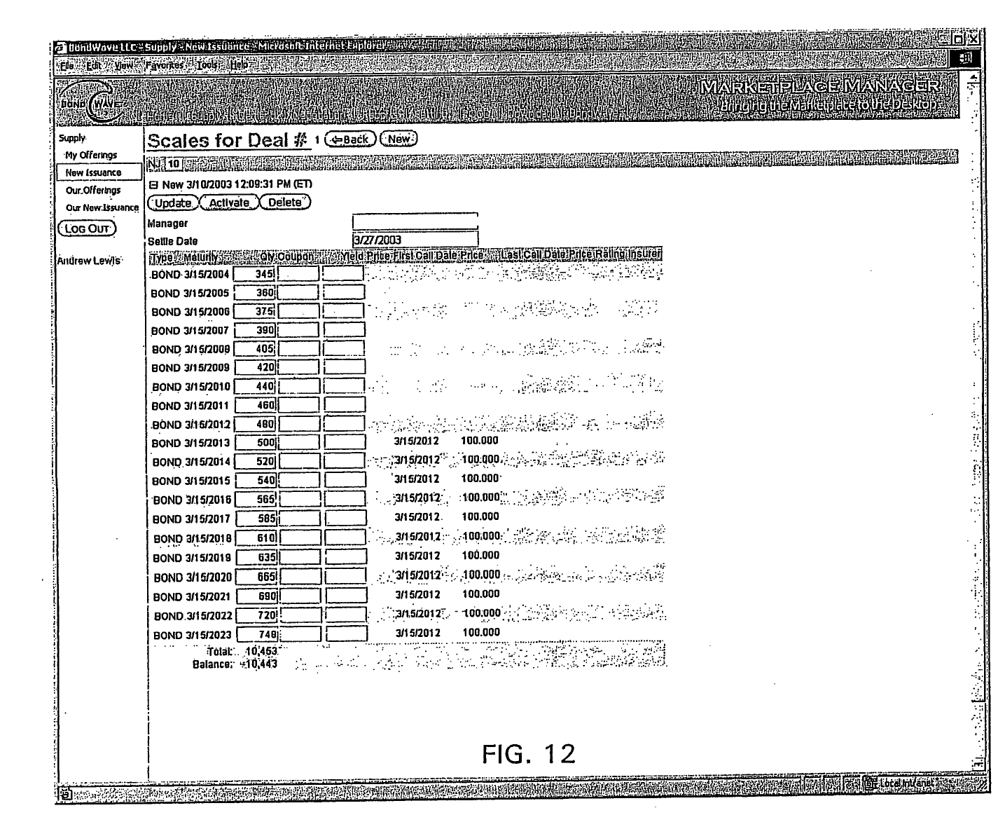

Preferably, such new issuance information can be filtered by new issuance security characteristics such as by state of issuance and sale date. Preferably, broker/dealers can also create and maintain scales information for each new issuance through an interface such as that shown in FIG. 12. A scale defines the structure of the securities that comprise a new issuance deal. A new issuance scale consists of a par amount, coupon rate, yield and dollar price for each security. While multiple scales can be created by a broker/dealer for each new issue, preferably, only one may be active at any given time for the purpose of obtaining pre-sale orders.

C. Our Offerings

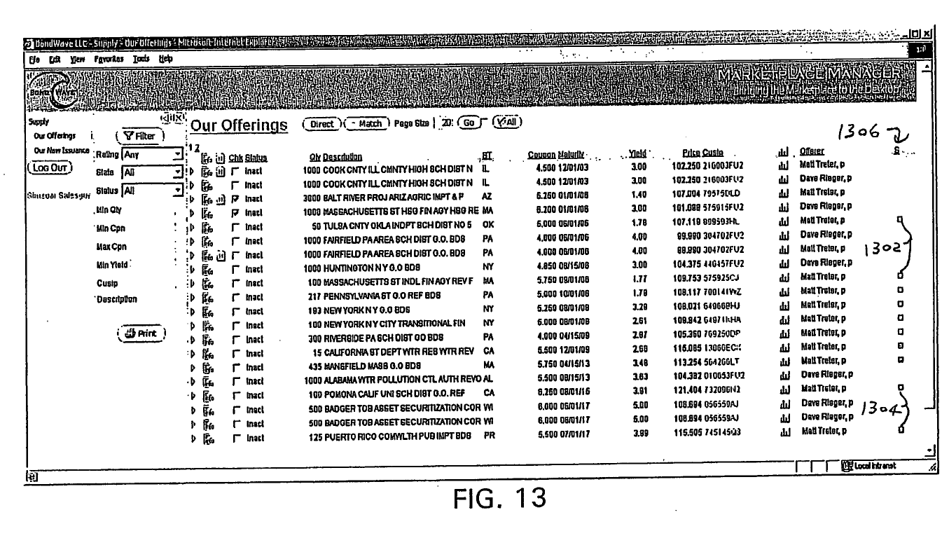

An exemplary Our Offerings screen display in accordance with one embodiment of the present invention is shown in FIG. 13. The FIG. 13 screen display is highly similar to the My Offerings screen display of FIG. 2, except that the offerings listed in FIG. 13 include all the offerings that are listed in the electronic securities management and trading system of the present invention for the sell-side user's firm, instead of just the offerings for which an individual trader is responsible. Preferably, a sell-side user may only edit those offerings specifically managed by him in this section, that is, this sell-side user may not modify those offerings of other sell-side users belonging to his firm.

D. Our New Issuance

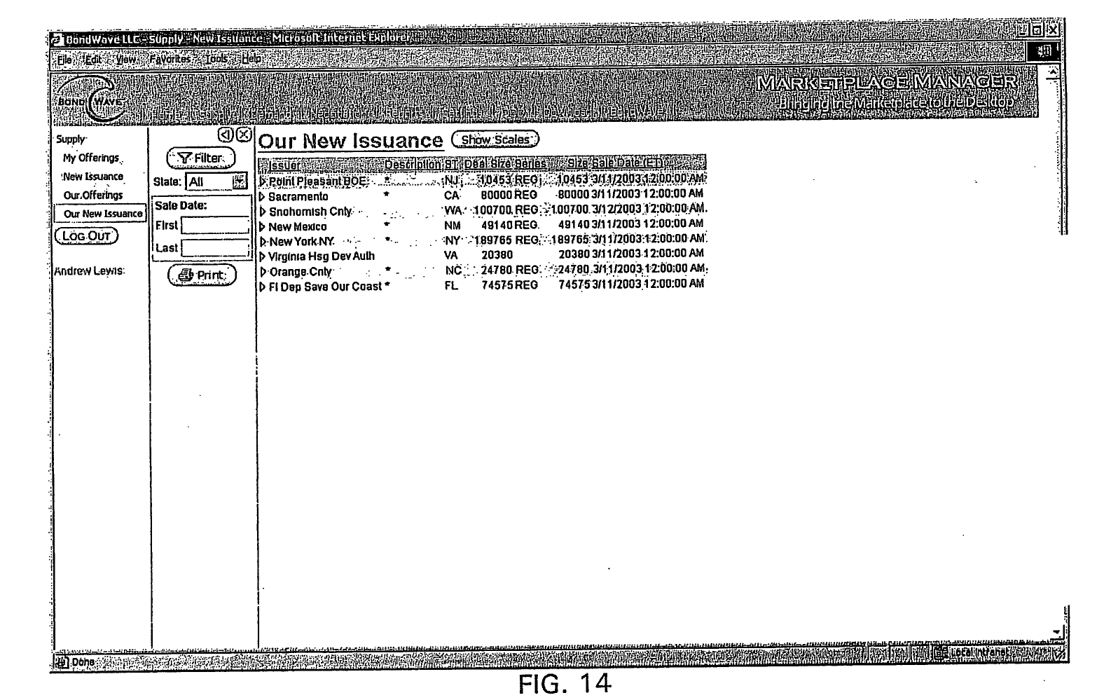

The Our New Issuance screen display of the exemplary MMan software application shown in FIG. 14 shows all new issues related to a sell-side user's firm. As with the Our Offerings screen display of FIG. 13, the user may view each new issuance and the corresponding scales corresponding to his firm, but preferably may not edit those new issuances of other sell-side users of his firm.

III. Demand

One of the core features of an embodiment of the current invention is its ability to aggregate demand consisting of the combined characteristics of buy-sought securities for all buyers using the electronic securities management and trading system of the present invention. This aggregated demand is displayed in real-time and can be searched, filtered, viewed and matched against security offerings on an ad hoc basis.

The demand section of the exemplary software application in accordance with one embodiment of the current invention can be divided into two primary areas: Inquiry Driven Demand and Portfolio Driven Demand.

A. Inquiry Driven Demand

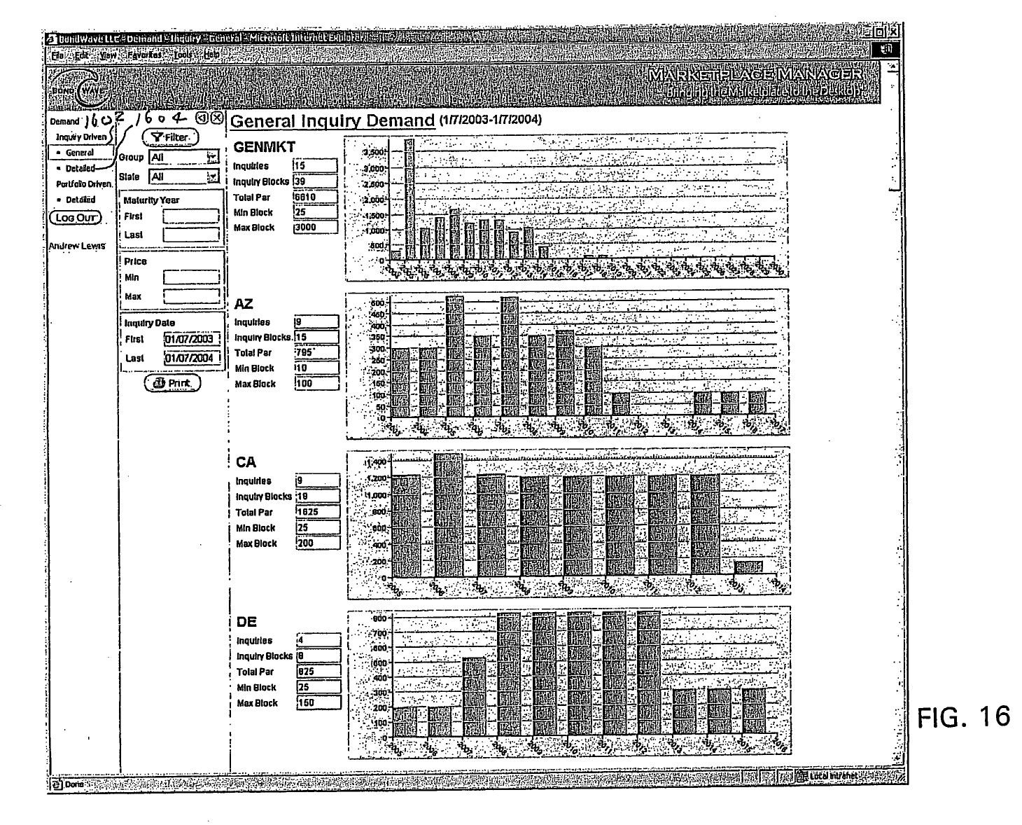

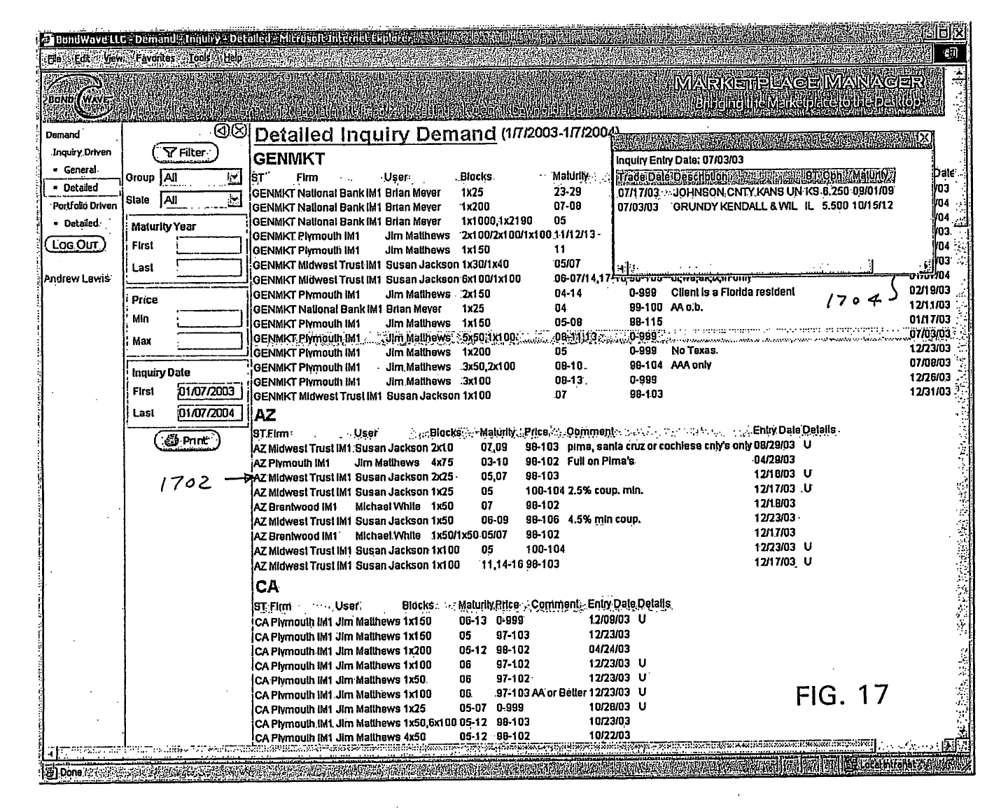

Inquiry demand in the present invention includes the characteristics of buyer-sought securities as entered into the electronic management and trading system by buy-side users using compatible software applications such as application 50 (e.g., the InqMan software tool available from BondWave, LLC) in FIG. 1A. As shown in FIG. 16, inquiry demand can preferably be viewed by system users in a general overview format, or in a detailed format by clicking on a General button 1602 or a Detailed button 1604 respectively.

As also shown in FIG. 16, the General Inquiry Demand format provides a graphical representation of aggregated demand summarized by demand characteristics such as by maturity year and state of issuance. The graphs preferably also show the user other relevant summary statistics such as the number of inquiries, total inquiry blocks, total par amount, minimum block size, maximum block size, etc. Preferably, the user can also filter the data according to specific criteria such as state of issuance, maturity year range, dollar price range, inquiry date range, etc.

As shown in FIG. 17, Detailed Inquiry Demand shows the characteristics of each inquiry in detail. This characteristic data preferably includes state of issuance, firm name, buy-side user name, number of inquiry blocks, maturity date range, dollar price range, inquiry specific comments, date the inquiry was entered, etc.

Clicking on an inquiry detail item of the Detailed Inquiry Demand screen display of the exemplary MMan software application such as item 1702 of FIG. 17 preferably brings up a window 1704 of FIG. 17 showing the investment securities that have already been purchased and allocated to the inquiry. Window 1704 preferably shows the characteristics of previously purchased securities such as trade date, security description, state of issuance, coupon rate, maturity date, etc. Access to a description of previous trade activity for a buy-side inquiry helps to give sell-side users better information about which type of offerings might interest the buyer as he buys for the client account that the inquiry represents.

B. Portfolio Driven Demand

Portfolio demand in the present invention includes the characteristics of buyer-sought securities as entered into the electronic securities management and trading system of the present invention by buyers using compatible software applications such as application 40 (e.g., the PCMan software tool available from BondWave, LLC) in FIG. 1A. These characteristics are based on the investment/compliance models defined by money managers as they service their client accounts. These investment models, along with the dollar amounts of the security types sought, are displayed to sell-side users so that they can identify appropriate offerings to fulfill these needs. As sell-side users find matching investment securities for the demand, they can direct corresponding offerings to the appropriate buy-side users.

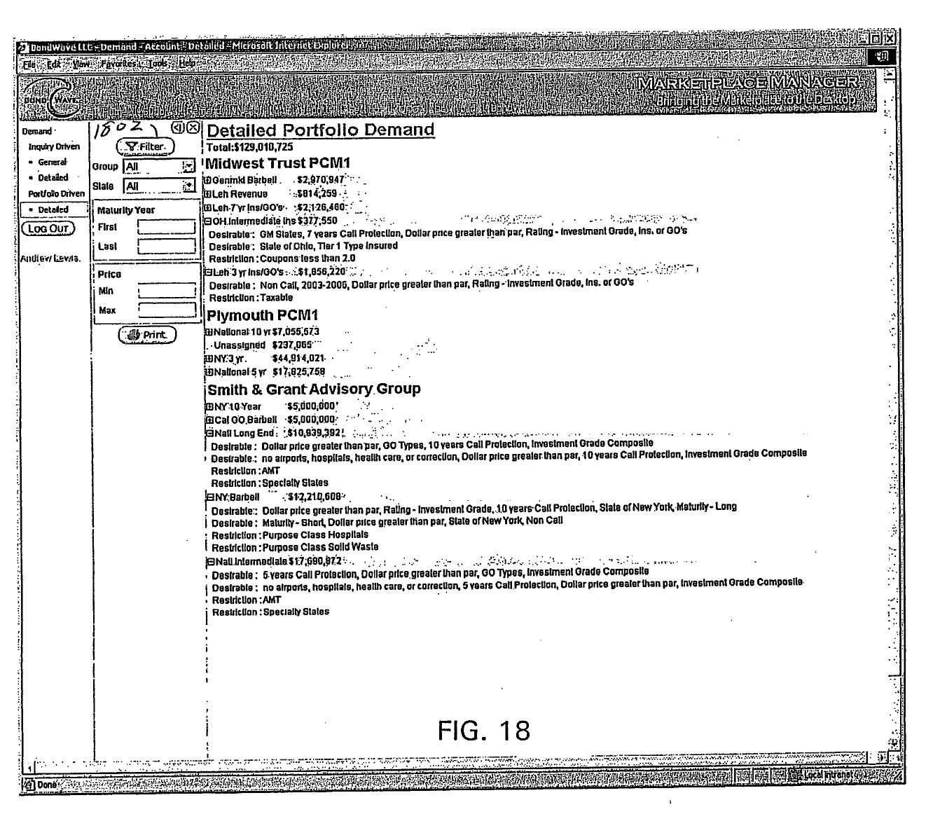

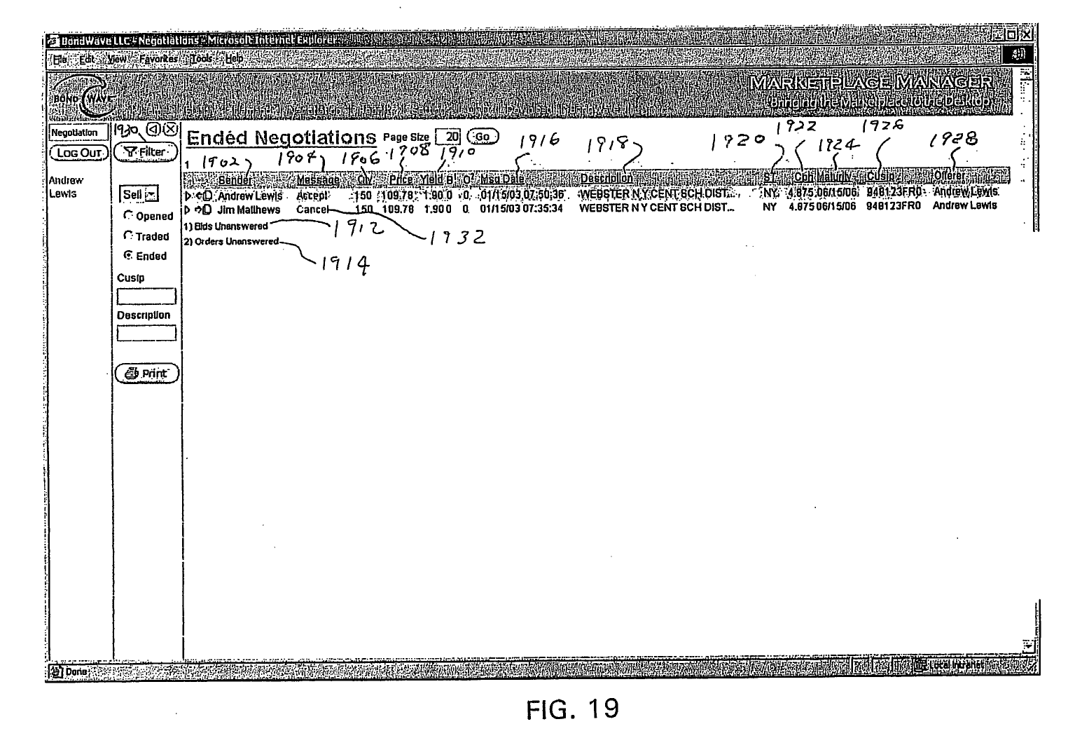

The detailed view of Portfolio Driven Demand of the exemplary MMan software application, as shown in FIG. 18, displays each buy-side firm, such as Midwest Trust, Plymouth and Smith & Grant Advisory Group in this example, and their corresponding investment models, such as Genmkt Barbell. Preferably, the amount of cash available for investment in each model (sum of cash available for the associated portfolios) is also displayed. Each model can be expanded to show the details of the security characteristics sought by the buy-side user including any investments restrictions.

The filter pane 1802 allows the user to filter data according to group (as described in the Settings section below), state of issuance, maturity year range, dollar price range, and coupon rate range, etc.

IV. Negotiation

A Negotiation in the context of this exemplary software application in accordance with one embodiment of the present invention is a series of electronic messages exchanged between two parties in the electronic securities management and trading system of the present invention for the purpose of establishing the terms of trade execution for an investment security transaction. A negotiation is preferable initiated by a buyer with an entry of a Bid or Order message, and is completed by the seller with the entry of an Accept or Reject message. Either party can end a negotiation by submitting a Cancel message, effectively canceling the last message they sent.

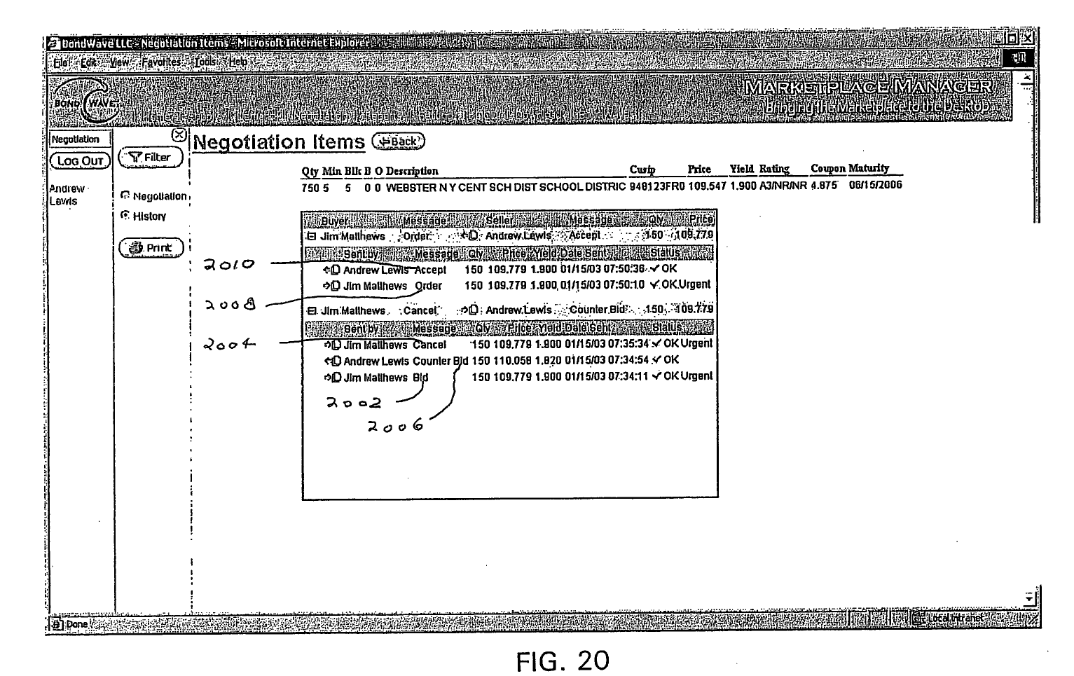

As shown in FIG. 19, a queue is created when multiple potential buyers initiate a negotiation for the same offering, thus forming a line of interested parties. When a queue exists, the sell-side user preferably deals with the bids and orders from buy-side users on a first in, first out basis.

Included with each investment security offering item of FIG. 19 in accordance one embodiment of the present invention is the sender name 1902, message status 1904, quantity 1906, dollar price 1908, yield 1910, current bids unanswered 1912, current orders unanswered 1914, date/time of the most recent message 1916, security description 1918, state of issuance 1920, coupon rate 1922, maturity date 1924, CUSIP 1926, and offerer name 1928.

Examples of different message statuses are as follows:
Accept—Negotiations ended with the offerer accepting the terms of the bid.
Reject—Negotiations ended with the offerer rejecting the terms of the bid.
Cancel—The buy-side user canceled his bid.

In the filter pane 1930, the user may filter negotiations by buys or sells, and also according to the negotiation status. Specifically, negotiation statuses are as follows:
Opened—Shows what negotiations are still ongoing.
Traded—Shows all completed negotiations that ended in a trade.
Ended—Shows all completed negotiations, regardless of whether or not it ended in a trade.

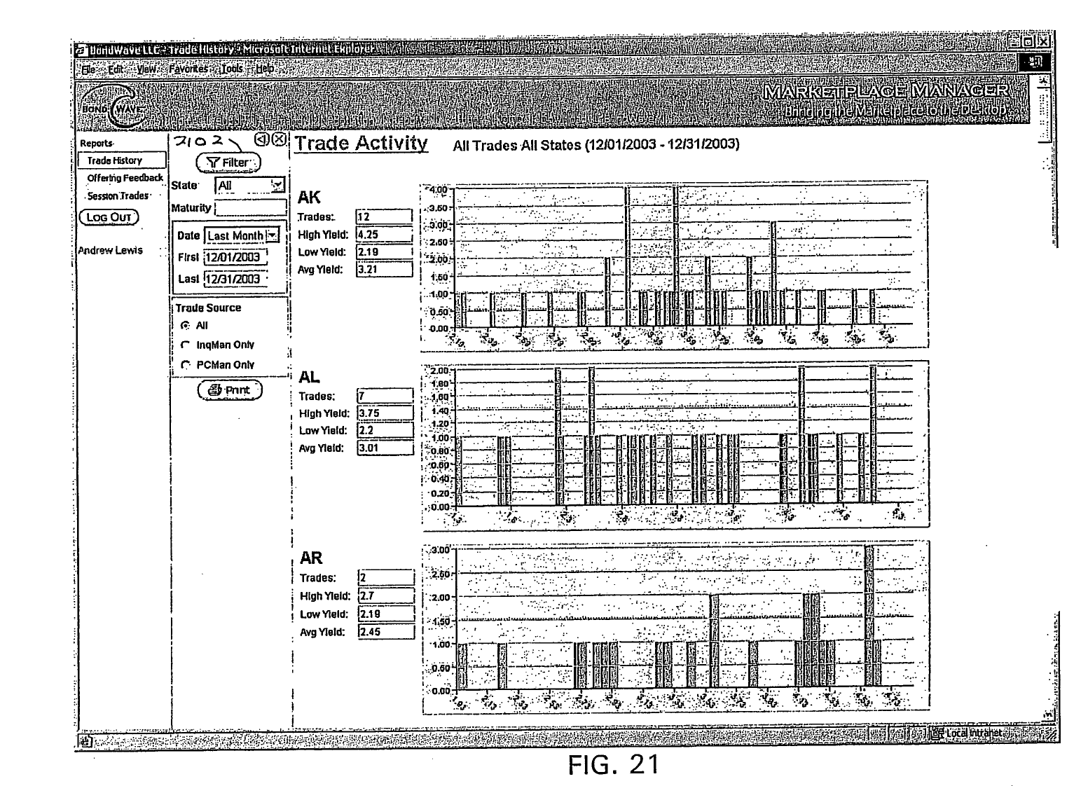

Clicking on a message status, such as item 1932, will bring up a screen display as shown in FIG. 20 displaying the history and outcome of all negotiations that have taken place on the selected offering.

Example negotiation actions that can be performed using the exemplary MMan software application are explained below:
Order—An Order message is sent by a buyer indicating his willingness to purchase an active offering that satisfies the quantity restrictions (multiples of, minimum block size) and dollar price established by the seller. Orders preferably must be filled by the seller if the quantity balance in the System is sufficient to do so. If the balance is not sufficient, due to previously completed negotiations that were added to the queue prior to the Order message being sent, the seller may enter a Counter Order as described below.
Bid—A Bid is a message sent by a buy-side user indicating the terms under which he would be willing to purchase an offering, where the quantity and/or price differs from the quantity restrictions and/or dollar price established by the seller. The seller preferably is required to respond to each Bid made by a buy-side user.
Counter Order—A Counter Order message may be sent by the seller when the seller receives an Order for one of his offerings which no longer has a sufficient balance to fill the Order, due to completed negotiations that were added to the queue prior to the Order message being sent. The Counter Order effectively notifies the buy-side user that the offered amount of the security has been reduced to the remaining balance, allowing the buy-side user the first right of refusal to the revised offering.
Counter Bid—A Counter Bid message may be sent by the seller when he receives a Bid he deems to be unacceptable, and responds with revised quantity restriction and/or dollar price terms.
Accept—An Accept message is sent by a seller after an Order or an acceptable Bid is received from a buyer. A successful negotiation preferably always ends with an Accept message.
Reject—A Reject message is entered by a seller in response to an unacceptable Bid from a buyer. A Reject message ends a negotiation and removes the buyer from the queue. After this action, the seller can move on to the next message in the queue.
Cancel—A Cancel message may be sent by either a buyer or a seller to cancel their last message. This message will terminate an open negotiation. A buyer preferably can cancel a previously sent Bid or Order that has not been accepted, or as a response to an unacceptable Counter Bid or Counter Order from the seller. Likewise, a seller can use the Cancel message in the same way to cancel a Counter Bid or Counter Order. Canceling a message removes the buyer from the queue, allowing the seller to proceed to the next Bid or Order in the queue

Preferably, buy-side users can see the total number of bids and orders ahead of them if a queue exists for an offering and sell-side users can see the total number of bids and orders in a queue. Preferably, buy-side and sell-side users will not be able to see the details of bids and orders in the queue other than the current one.

In accordance with one embodiment of the present invention, if there are orders on an offering, the owner of that offering preferably cannot delete it or make it inactive. Rather, he preferably has an obligation to fill the order. This does not pertain to bids, in accordance with this embodiment of the present invention, in which case the offerer can preferably delete or inactivate the offering.

V. Reports

The exemplary MMan software application provides several report views compiled from real-time data generated by buy-side and sell-side users of the system.

A. Trade History Report

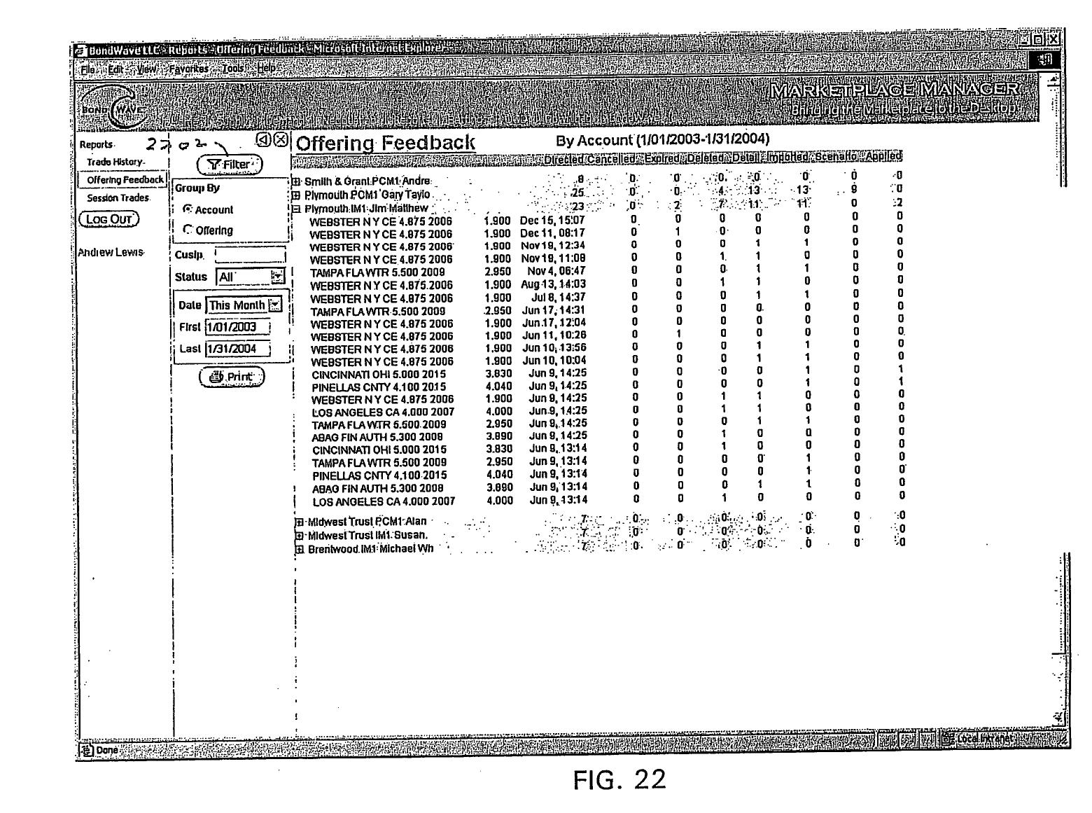

A Trade History Report of MMan, as shown in FIG. 21, displays a graphical representation of the trade activity completed across all buy-side users of the electronic securities management and trading system in accordance with one embodiment of the present invention. Similar to the Trade Activity screen display of FIG. 8 described earlier, this screen displays a “bar chart” graphic of all completed trades in the securities management and trading system for a given date, including the number of trades and their associated yields. Using the filter pane 2102, sell-side users can filter the trade data by the source of the buy-side demand (Inquiry or Portfolio Driven Demand) and/or by securities characteristics such as maturity year range, state of issuance, and trade date range. Filtered trade data reflecting the characteristics of the securities held in the sell-side user's inventory or those he is considering for purchase helps him as he makes pricing decisions for those securities. The Trade History Report of MMan also can be used to determine how the sell-side user's trade activity compares with other sellers using the system.

B. Offering Feedback Report

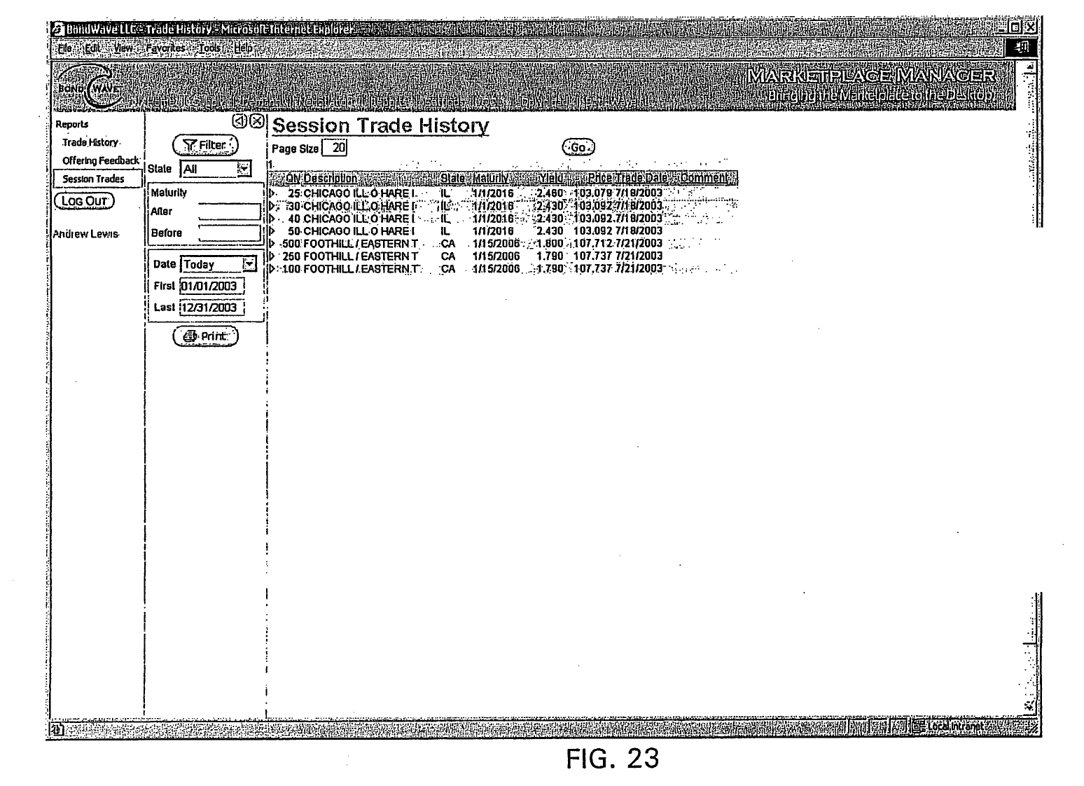

Within the electronic securities management and trading system, sellers are preferably provided with real-time feedback for their directed offerings grouped by the directed offering or by the buy-side users who received the offering. As the buy-side users receiving directed offerings evaluate, import or delete the offerings utilizing their compatible software applications, their actions are recorded for the seller to review in the Offering Feedback Report screen display shown in FIG. 22.

Preferably, the user may control which feedback information is displayed via a filter pane 2202 as shown in FIG. 22. The meanings of the exemplary column headers in FIG. 22 are as follows:

1) Directed—Indicates the total number of offerings that have been directed to the specified buy-side user. If grouped by offering, this indicates the total times the offering has been directed.

2) Cancelled—Indicates that the seller recalled the directed offering and it was never received by the buy-side user's compatible software application.

3) Expired—Preferably, directed offerings are good only on the day on which they are directed. Otherwise, they are considered to have expired. An expiration status for a directed offering indicates that the buy-side user received it through his compatible software application, but he took no further action related to it.

4) Deleted—Signals that the directed offering was received by the buy-side user and subsequently deleted. The buy-side user may or may not have examined it in more detail before deleting it.

5) Detail—Indicates that the buy-side user examined the directed offering in more detail, regardless of whether he ended up deleting or importing it.

6) Imported—Indicates that the directed offering was imported into the buy-side users compatible software application for further analysis.

7) Scenario—Indicates that the buy-side user attempted to match the directed offering with his client's demand using his compatible software application.

8) Applied—Indicates that the directed offering was imported into the buy-side user's compatible software application and resulted in a trade.

Each account or directed offering displayed in the report preferably can be expanded to view all the corresponding feedback.

C. Session Trades Report

A Session Trades Report of MMan, as shown in FIG. 23, preferably displays a session trade history for the user. Preferably, these trades can be filtered by investment security characteristics such as state of issuance, maturity date range, trade date range, etc. More details related to Sessions are described below.

VI. Settings

This section of the exemplary marketplace management software application (MMan) preferably allows sell-side user to customize and modify certain default settings and modes of operation of the application.

A. Restriction List

The Restriction List screen display of MMan shown in FIG. 24 provides the sell-side user with an interface to view and update which system users he has restricted from viewing his offerings as well as viewing which system users have restricted him from viewing their buy-side demand and/or offerings. Restrictions work reciprocally, that is, if a sell-side user restricts a system user from viewing his offerings, then that sell-side user will be prevented from viewing any buy-side demand information generated by the restricted system user and vice versa.

On the Restriction List screen display of the exemplary MMan software application, system users are grouped by firms which can be expanded to show the individual system users employed at the same firm. Restrictions can be established for a selected system user or for all system users which are employed at a firm. Clicking the check box corresponding to a firm to “checked” restricts all system users employed at the firm. For example, if the user clicks on Brown & Co. Investments 2402 of FIG. 24, a check appears in the check box 2404 indicating that Brown & Co. Investments is prevented from viewing any offerings made by the sell-side user, and the sell-side user is prevented from viewing any demand information pertaining to Brown & Co. Investments. Restrictions can also be established at the system user level without effecting other system users employed at the same firm. For example, if the sell-side user clicks on Matthews Jim 2406, a check appears in box 2408 indicating that Matthews Jim has been restricted, but that other system users at Plymouth Asset Management 2410 have not been restricted. The system user applying the restriction and the restricted system user may be either a buy-side or a sell-side user.

Utilizing this screen display and the “yes/no” option 2414, sell-side users can further control how their offerings are viewed by other system users by setting the contra-party to anonymous.

B. Group List

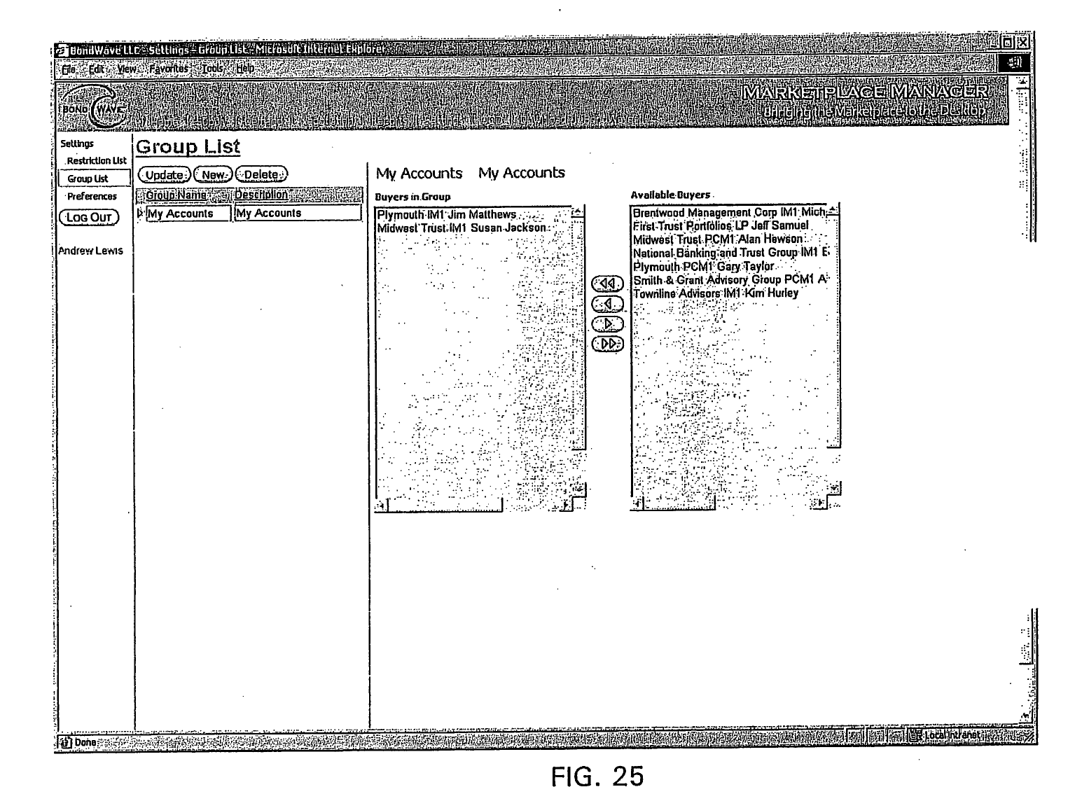

Groups can be used as a way of combining demand from multiple buy-side users. Groups can also be used to facilitate directing an offering to more than one system user. Through the use of the Group List screen display of MMan as shown in FIG. 25, sell-side users can create and name groups containing multiple system users.

C. Preferences

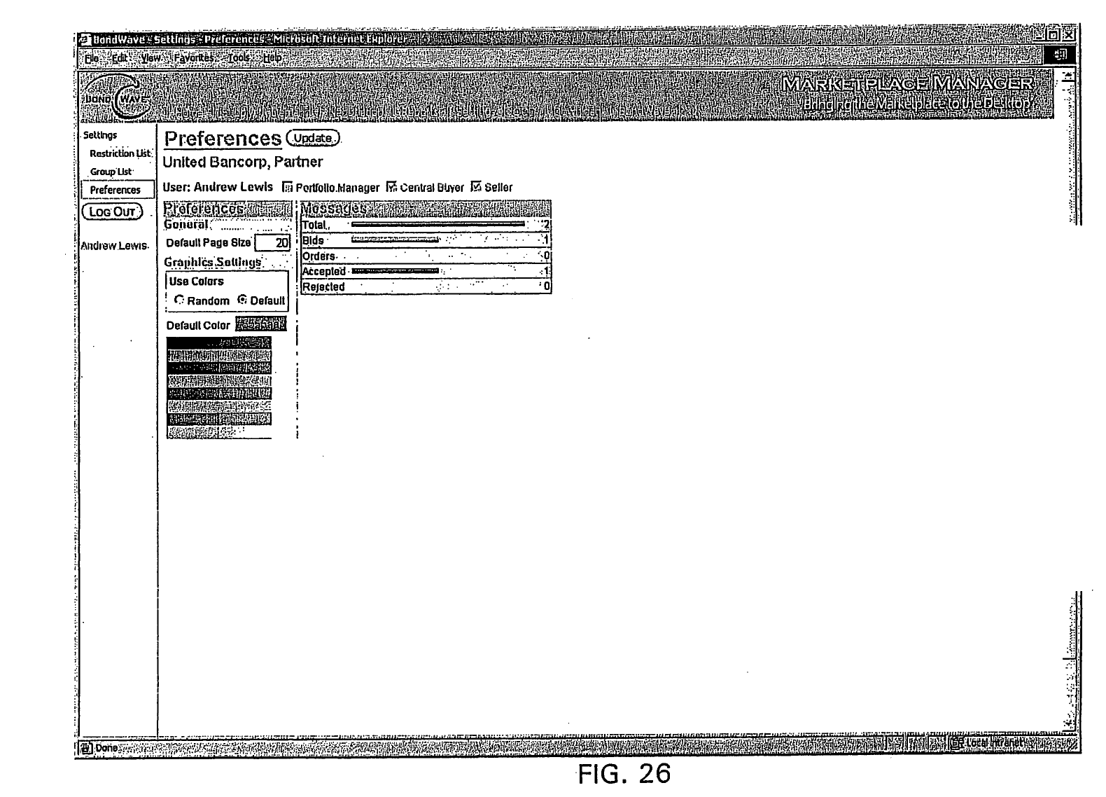

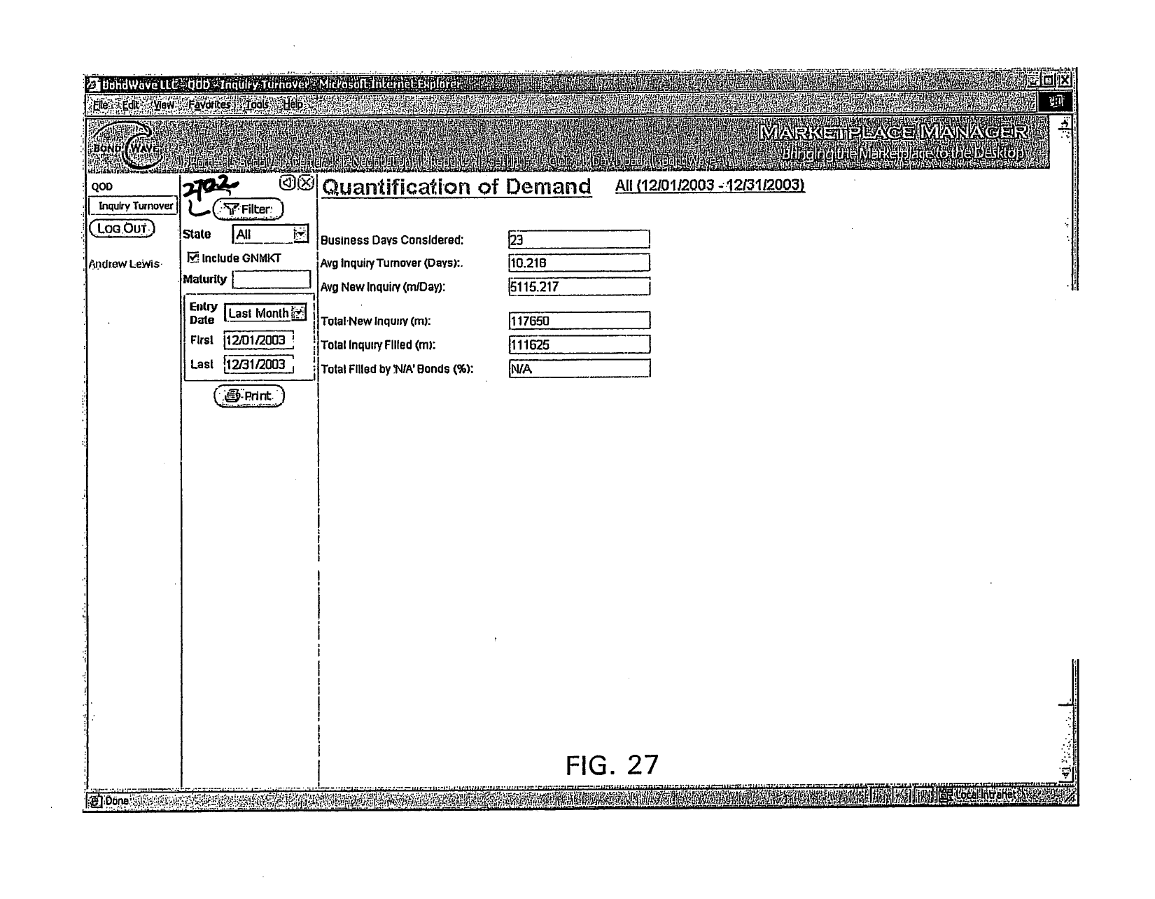

A Preferences screen display shown in FIG. 26 enables users to customize page size and color scheme. It also gives an overview of message activity.

VII. Quantification of Demand

A. Inquiry Turnover

The Quantification of Demand (QOD) screen display of the exemplary MMan software application shown in FIG. 27 provides the sell-side user with an interface to analyze real-time aggregate measures of current and past buy-side demand. Sell-side users can view buy-side demand information such as Total New Inquiries (par amount), Total Inquiry Filled (par amount), Average Inquiry Turnover (Days), and Average New Inquiry (par amount per day). Utilizing the filter pane 2702, the sell-side user can filter the buy-side demand and past purchase information according to state of issuance, maturity date range, trade date range, etc. Analyzing how past buy-side demand has been filled along with real-time access to what is currently sought by buy-side users, can prove useful to sell-side users as they manage the composition of their securities inventories.

Using the application tools and reports described below, the sell-side user can quantify and more deeply analyze the purchasing habits of the buy-side users. Quantifying how the buy-side demand has been filled in the past may help the sell-side user identify any general purchasing trends for the market segment or help create a security buying profile for a specified buy-side user. The sell-side user can then use these analyses, trends, and profiles to help him identify the most effective securities to add to his inventory and have a better appreciation on how long he can expect to own them.

Analyze Past Purchases

The exemplary MMan software application preferably provides an area that enables the sell-side user to view the total par amount of the securities purchased for a group of buy-side users in a graphical format based on the user's specified filter and view-chart settings. Filter settings can include options to specify the buy-side user(s) as well as the state of issuance, maturity date range, trade date range, and contra party information for the traded securities. The sell-side user can then, for example, view a graph (not shown) of the total par amount of the securities purchased (y-axis) by transaction/security characteristics such as trade date, maturity date, or state of issuance (x-axis).

QOD Summary Report

The QOD Summary report (not shown) of the exemplary MMan software application provides the sell-side user with a deeper analysis of the buying habits of the specified buy-side users. From this report, the sell-side user may begin to develop a buying profile for the buy-side user through the use of the buying statistics contained therein. Statistics can include the total par purchased, average par amount block size, average spread (in basis points) of the purchase yield to an underlying benchmark yield curve, state of issuance ranking by total par amount purchased, maturity date range and average coupon rate breakdown of the securities purchased.

B. Download

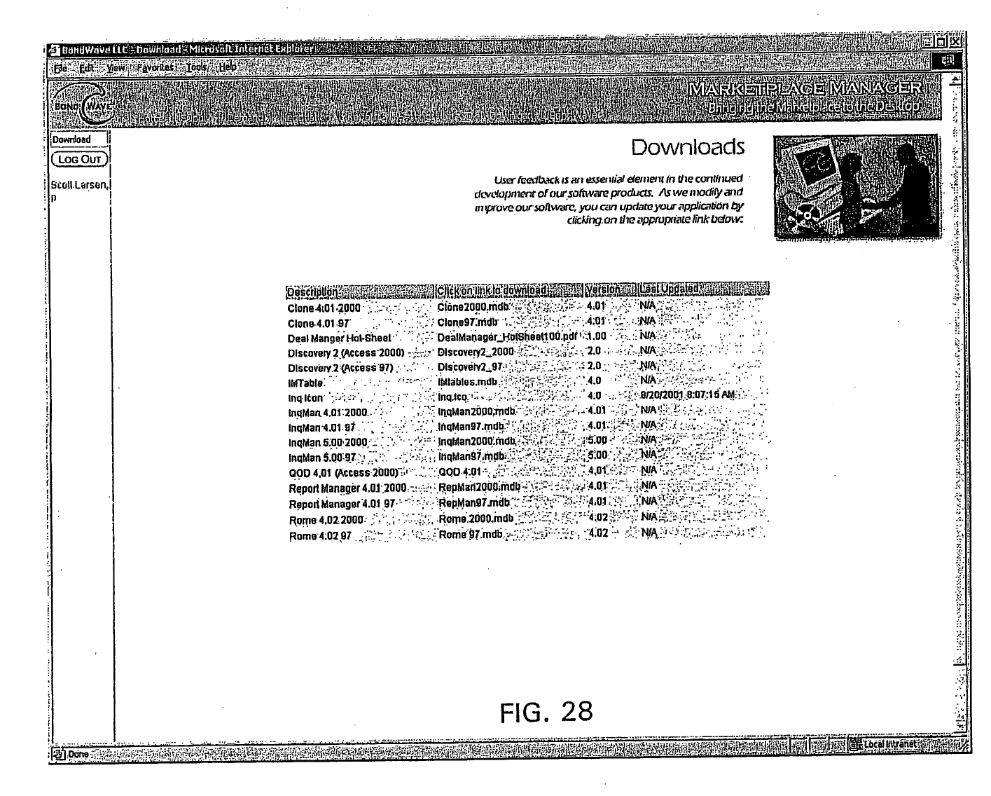

The download section of the exemplary MMan application is the central repository for all application updates and new release versions. FIG. 28 illustrates a screen display of the download section.

VIII. BondWave

The BondWave section of the exemplary MMan software application in accordance with one embodiment of the present invention displays offering and holding information as it pertains to the other users of the electronic securities management and trading system. For example, in this section, system users can search for, filter, and view offerings entered into the system by other system users. In this section, system users can also place Bids or Orders on the posted offerings, as well as view portfolio holdings of portfolio managers using compatible buy-side software applications such as application 40 (e.g., the PCMan software tool from BondWave, LLC) in FIG. 1A.

A. BondWave Offerings

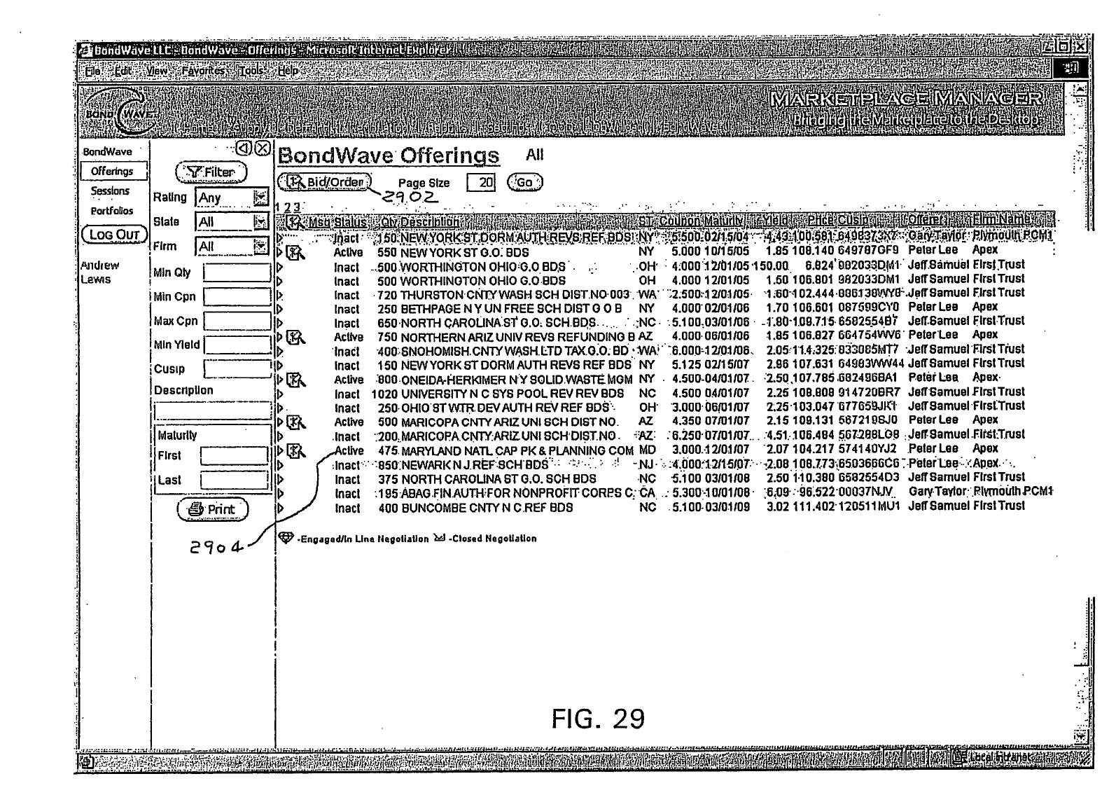

The BondWave Offerings screen display of MMan illustrated in FIG. 29 provides the sell-side user with a view of the offerings posted to the system by other system users. This is the primary area within the exemplary MMan software application where system users can place Bids or Orders on the posted offerings.

The page layout is preferably similar to the My Offerings screen display of FIG. 2, one difference being that this interface provides the system user with button 2902 enabling him to place bids or orders on the posted offerings. Clicking on the active status of an offering, such as item 2904, brings the user to a new screen display where he can specify the details of his bid or order. Submitting the details of the Bid or Order to the electronic securities management and trading system, effectively starts a negotiation dialogue between the users involved as previously described.

B. Sessions

Sessions in accordance with one embodiment of the present invention provide buy-side and sell-side users with a means to establish an exclusive arrangement for the sell-side user to market offerings made up of the securities held in the buy-side user's customer portfolios. Session items are remarketed offerings. The buy-side user retains control over the minimum offering terms under which the sell-side user can remarket the securities including the length of time he will be granted the right to do so. Sessions are established by a buy-side user through the use of a compatible software application such as application 40 in FIG. 1A (e.g., the PCMan software tool from BondWave, LLC). This mechanism also provides the buy-side user with real-time updates of a session's progress including the details of any resulting transactions and the remaining balances of the securities being offered.

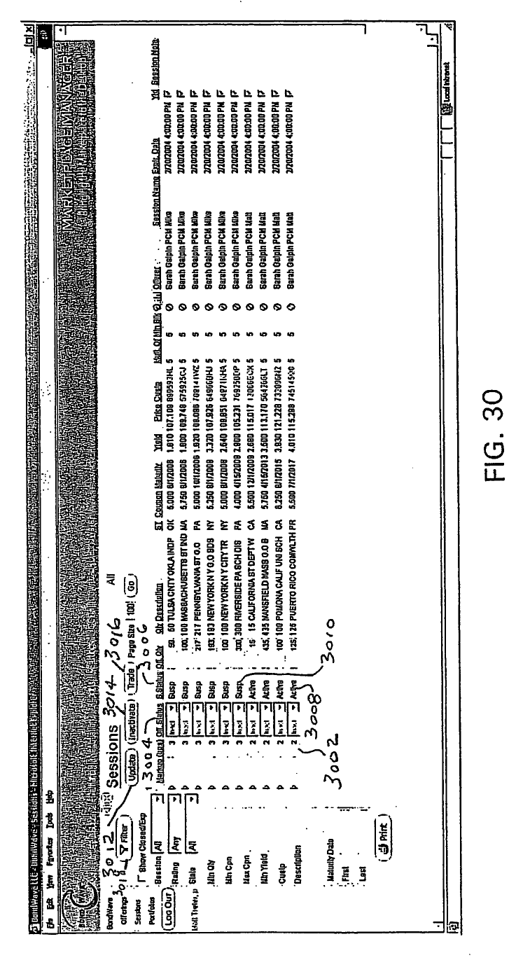

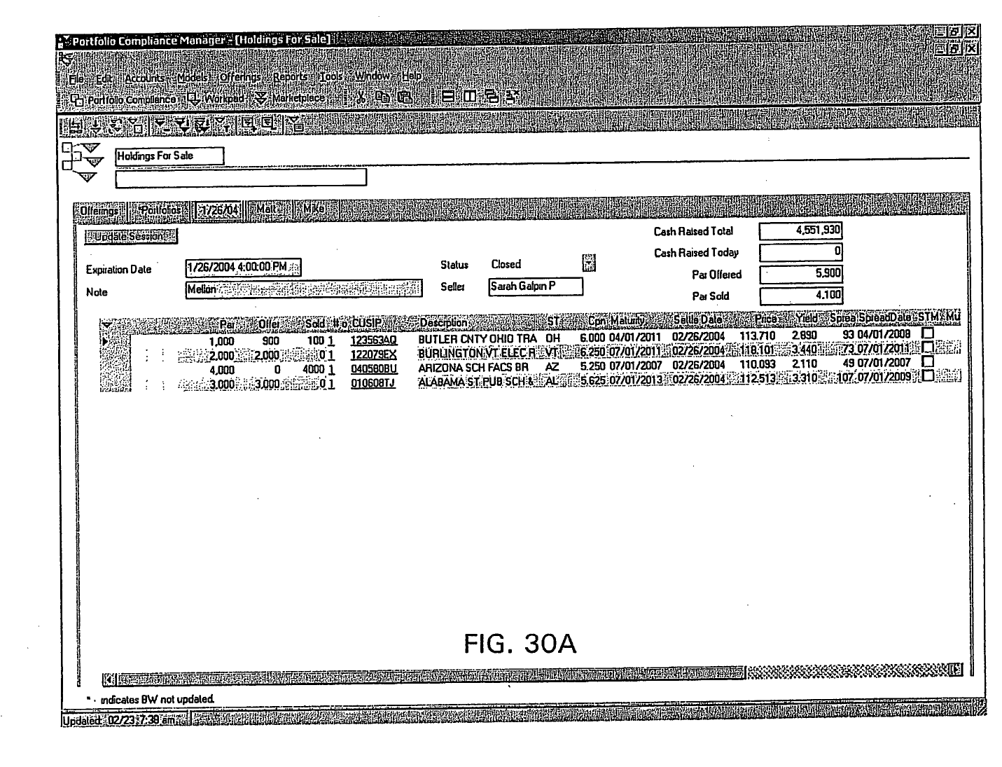

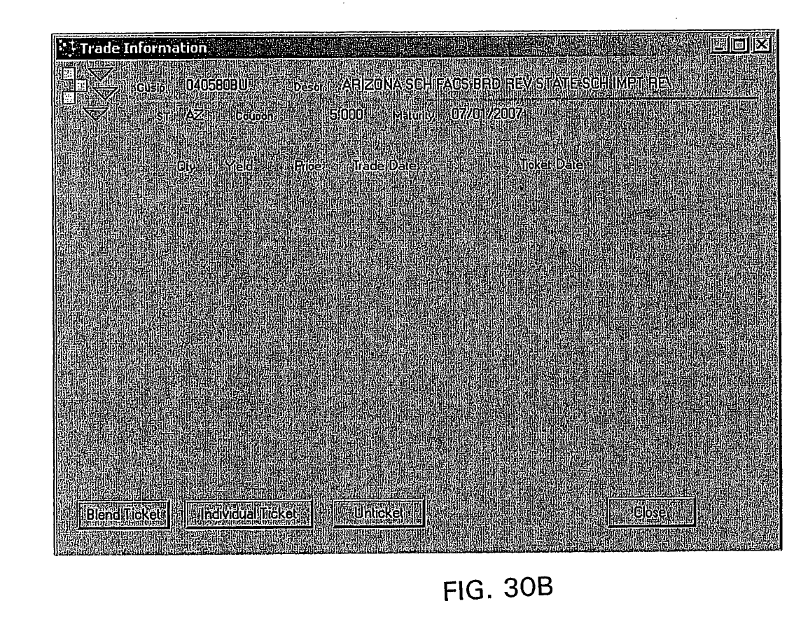

Once the terms of the sessions have been established, the broker/dealer can then make a “white-label” offering of the securities, as if they were part of his owned securities inventory. When making the “white-label” offering, the sell-side user must be mindful of the session parameters (dollar price, minimum block size, spread to benchmark curve, etc.) established by the buy-side user as shown in FIG. 30A. These parameters will define the quantities and cost basis of the securities to the sell-side user. The sell-side offering will be offered at a price greater than the price indicated in the session, typically entered in a basis point markup to the yield in a Markup (bps) field, such as field 3002, of the exemplary screen display shown in FIG. 30.

Broker/dealers can control how the session items will be viewed by other system users by setting the Offering Status 3004 to be Hidden, Inactive, or None. Session items with Offering Statuses of Hidden or None will not be viewable by other members of the user's firm, or other system users. By changing the Offering Status to Inactive, the sell-side user adds the session item to his list of offerings on the My Offerings screen display, which are viewable by other members of his firm under the Our Offerings screen display shown in FIG. 13 as well as by other system users.

On the Our Offerings screen display of MMan, session items can be preferably identified by, for example, yellow flags 1302, or green flags 1304, in the session field 1306. The flag color corresponds to the session status on the Sessions screen display of the exemplary MMan software application as shown in FIG. 30. Session statuses are controlled by the buy-side user through his compatible software application, such as the PCMan software application as shown in FIG. 30A. Session statuses cannot be changed by the broker/dealer.

Referring again to FIG. 30, Session statuses 3006 are also preferably shown on the Sessions screen display. Session statuses may be Active, such as item 3008, which is displayed as a green flag 1304 on the Our Offerings screen display of FIG. 13, Suspended, such as item 3010, which is displayed as a yellow flag 1302 in FIG. 13, or Closed (session item not shown). These session statuses indicate whether the buy-side user wants the session item offered, hidden, or ended respectively.

As shown in the Sessions screen display of the exemplary MMan software application depicted in FIG. 30, a broker/dealer may update the details of the Session item utilizing the buttons described below:
i. Update—Clicking Update button 3012 allows the seller to change the markup on one or more of the holdings.
ii. Inactivate—Clicking Inactivate button 3014 will set the Offering Status 3006 to Inactive for all session items.
iii. Trade—Clicking Trade button 3016 will bring up a new pop-up window where the user can specify the details of the trade.

Through the use of his compatible software application, the buy-side user is provided with a means to automatically re-price the offerings in the session to reflect any market movements. The offerings are often quoted as an interest rate difference, or “spread,” (typically in basis points) from a benchmark yield curve. Since the security's yield and corresponding price are based on a spread or difference from the underlying yield curve, if that underlying yield curve changes, reflecting an overall market movement, then the security's price established by the buy-side user will automatically adjust accordingly. Any changes will also automatically be reflected in the corresponding sell-side user's “white-label” offering.

Until the session expires, and as trades are completed on the offerings, the related trade information is communicated back to the investment manager using a compatible software application (e.g., the PCMan software tool from BondWave, LLC), the details of which are used to update his customer's portfolio holdings. Traded quantities are totaled for the traded offering that are made up of multiple security lots. Right-clicking a session item in FIG. 30A enables the user to view the details of the quantities traded on his behalf as shown in FIG. 30B.

Referring back to FIG. 30, by using filter pane 3018, Session Items can be filtered according to associated session name, credit rating, state of issuance, quantity, coupon rate, yield, CUSIP, security description, maturity date, etc.

C. Portfolios

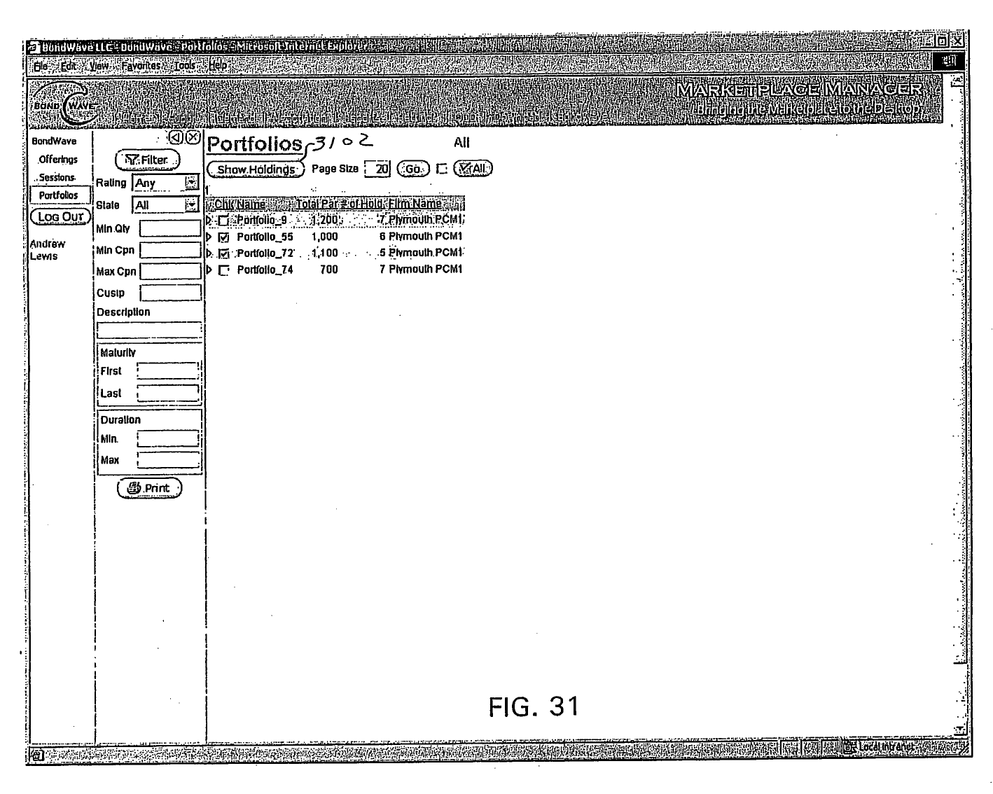

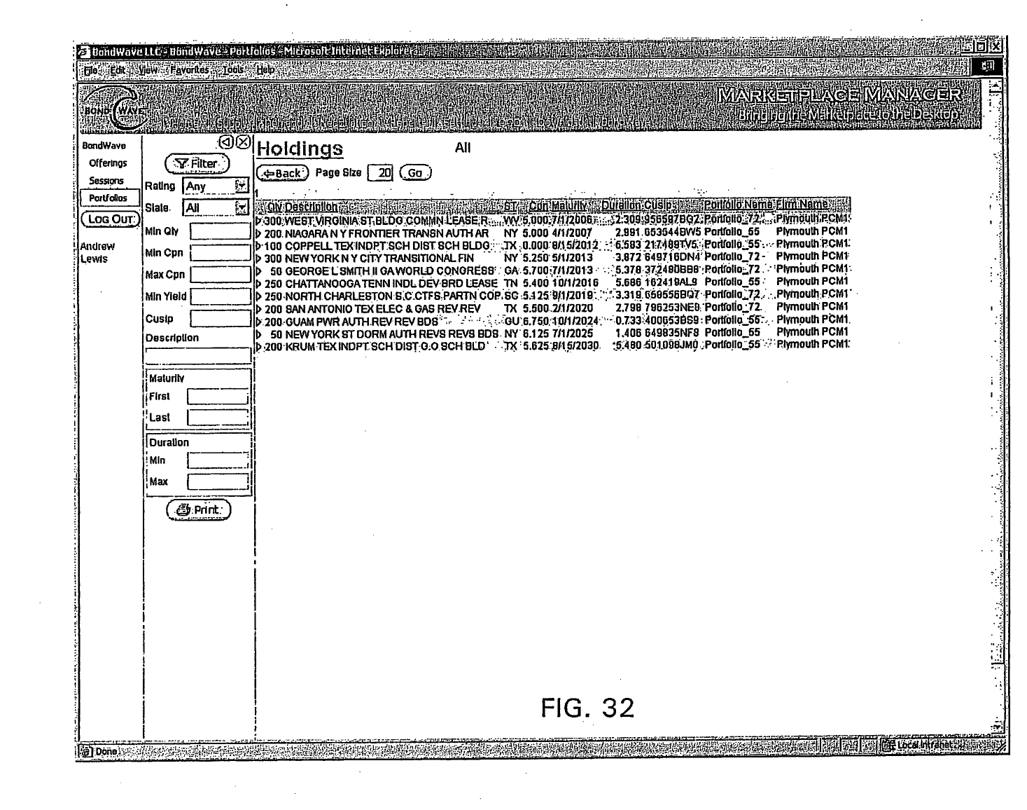

Portfolios in the present invention represent the securities held by individual or institutional investors that are being managed by buy-side users utilizing compatible software applications such as application 40 (e.g., the PCMan software tool from BondWave, LLC) in FIG. 1A. These buy-side users post their customers' portfolios to the electronic securities management and trading system of the present invention making them visible to one or more broker/dealers to generate trade ideas. Similar to sessions, the buy-side user loads portfolios to the system and grants sell-side users access to them by utilizing a compatible software application such as application 40 (e.g., the PCMan software tool from BondWave, LLC) in FIG. 1A. Once the portfolios are in the system and access has been granted, the sell-side user can utilize the screen display shown in FIG. 31 to select a portfolio by clicking button 3102 to view its corresponding securities holdings as shown in FIG. 32.

As shown in FIG. 32, the sell-side user can filter portfolios and their respective holdings by securities characteristics such as credit rating, state of issuance, quantity, coupon rate, yield, CUSIP, security description, maturity date, duration, etc.

Being granted access to the security holdings enables the sell-side user to make additions to his displayed securities inventory without exposing himself to many of the risks and costs associated with actually owning the added securities. In an effort to identify which securities could be remarketed, the sell-side user can select and match the securities from the buy-side user's portfolio against buy-side demand using the matching algorithms described previously. If the selected securities effectively match buy-side demand and the parties can agree on the terms of a transaction, the sell-side user can solicit the buy-side user that owns them to offer him the securities. If the parties agree to the terms of a transaction, the sell-side user can then market the securities in the system now as part of his owned securities inventories.

While the invention has been described with reference to one or more preferred embodiments and an exemplary marketplace management software application (MMan) and other exemplary software applications (e.g., PCMan and InqMan), those skilled in the art will understand that changes may be made and equivalents may be substituted without departing from the scope of the invention. In addition, many modifications may be made to adapt a particular step, structure, or system to the teachings of the invention without departing from its scope. Therefore, it is intended that the invention not be limited to the particular embodiment disclosed, but that the invention will include all embodiments falling within the scope of the appended claims.

1. A method of managing fixed income securities offerings or characteristics of buyer-sought securities by users of a fixed income securities management and trading system employing a computer system and a computer communication network, comprising:
entering into the computer system characteristics of one or more fixed income securities offerings or buyer-sought securities by a first user; and
enabling the first user to control access to the entered characteristics by a second user via the computer communication network; wherein the access control comprises allowing the second user to view or preventing the second user from viewing the entered characteristics.

2. The method of claim 1, wherein the computer communication network is an Internet.

3. The method of claim 1, wherein the users comprise user entities and individual users employed by the user entities and wherein the second user is a user entity or an individual user employed by a user entity.

4. The method of claim 1 and further comprising enabling the first user to remain anonymous to the second user.

5. The method of claim 1 and further comprising automatically preventing the first user from viewing securities offering or securities demand information entered by the second user who has been prevented from viewing the characteristics of the securities offerings or buyer-sought securities entered by the first user.

6. A computer software application for the users to manage fixed income securities offerings or characteristics of buyer-sought securities, comprising a set of instructions that when executed by the computer system allows the first user to perform the method of claim 1.

7. A method of managing trading by buyers and sellers using a fixed income securities management and trading system employing a computer system and a computer communication network comprising:
entering into the computer system characteristics of buyer-sought securities sought by the buyers;
enabling at least one of the sellers to view the characteristics of at least one of the buyer-sought securities via the computer communication network;
entering into the computer system characteristics of seller-offered securities offered for sale by the sellers;
matching some or all of the characteristics of some or all of the buyer-sought securities with the corresponding characteristics of some or all of the seller-offered securities by using the computer system to identify seller-offered securities matching buyer-sought securities;
enabling at least one of the sellers of the matching seller-offered securities to direct one or more of the matching seller-offered securities to the attention of at least one of the buyers seeking the buyer-sought securities having the matched characteristics via the computer communication network; and
enabling the at least one buyer seeking the buyer-sought securities having the matched characteristics to view the characteristics of the directed one or more matching seller-offered securities via the computer communication network.

8. The method of claim 7, wherein the seller offered securities comprise new issuance securities.

9. The method of claim 7, wherein the computer communication network is an Internet.

10. The method of claim 7 wherein the directed one or more matching seller-offered securities appear to the at least one buyer in a pop-up screen display window generated by the computer system and visible to the at least one buyer.

11. The method of claim 7 and further comprising:
enabling the at least one buyer to take actions with respect to the directed one or more matching seller-offered securities via the computer communication network;
making a record of the actions taken by the at least one buyer using the computer system; and
enabling the at least one seller of the matching seller-offered securities to view the record of the actions via the computer communication network.

12. The method of claim 11 wherein the actions comprise one or more actions selected from the group consisting of viewing additional detail for the directed one or more seller-offered securities, importing into the user's local database the directed one or more seller-offered securities, indicating the purchase of the directed one or more seller-offered securities, and deleting the directed one or more seller-offered securities.

13. The method of claim 11 wherein the at least one buyer comprises a buyer entity or an individual buyer employed by a buyer entity.

14. The method of claim 11, wherein the at least one buyer comprises a plurality of buyer entities.

15. A computer software application for the buyers and sellers to manage trading of fixed income securities, comprising a set of instructions that when executed by the computer system allows the buyers and sellers to perform the method of claim 7.

16. A method of managing trading by buyers and sellers using a fixed income securities management and trading system employing a computer system and a computer communication network comprising:
entering into the computer system characteristics of seller-offered securities offered for sale by at least one seller;
enabling at least one buyer to view the characteristics of the seller-offered securities via the computer communication network; and
enabling an electronic messaging dialog between the at least one buyer and the at least one seller about the seller-offered securities via the computer communication network.

17. The method of claim 16, wherein the messaging dialog comprises:
a buyer bid or order for at least one of the seller-offered securities; and
a seller acceptance of the buyer bid or order.

18. The method of claim 17, wherein the messaging dialog further comprises a seller counter bid or counter order.

19. The method of claim 18, wherein the messaging dialog comprise a plurality of rounds of electronic messages exchanged between the buyer and the seller.

20. A computer software application for the buyers and sellers to manage trading of fixed income securities, comprising a set of instructions that when executed by the computer system allows the buyers and sellers to perform the method of claim 16.

21. A method of managing fixed income securities offerings by users of a fixed income securities management and trading system employing a computer system and a computer communication network comprising:
entering into the computer system characteristics of buyer-sought fixed income securities sought by a buyer or characteristics of fixed income securities previously purchased by the buyer;
enabling a seller to select from a plurality of formats for viewing the entered characteristics via the computer communication network; and
enabling the seller to view the entered characteristics in the selected format via the computer communication network.

22. The method of claim 21 and further comprising filtering information of the buyer-sought fixed income securities or the fixed income securities previously purchased by the buyer based on the entered characteristics according to a preference of the seller.

23. The method of claim 22 wherein the filtering step comprises filtering according to associated buyer, state of issuance, maturity date range, price range, credit rating range, coupon range, inquiry entry date range, or purchase date range.

24. The method of claim 21, wherein the formats comprise a general format having a first level of detail and a detailed format having a second level of detail greater than the first level of detail.

25. The method of claim 24 wherein the general format comprises aggregate amounts of the buyer-sought fixed income securities and the number of individual inquiries.

26. The method of claim 24 wherein the detailed format comprises one or more characteristics selected from the group consisting of state of issuance, firm associated with an inquiry, user name, number of inquiry blocks, maturity date range, price range, credit rating range, inquiry comments and entry date of an inquiry.

27. A computer software application for the users to manage trading of fixed income securities, comprising a set of instructions that when executed by the computer system allows the users to perform the method of claim 21.

28. A method of managing trading by buyers and sellers using a fixed income securities management and trading system employing a computer system and a computer communication network comprising:
providing a seller with access to characteristics of a fixed income security owned by a first buyer to enable the seller to market the fixed income security owned by the first buyer;
entering into the computer system sale terms for the fixed income security for the marketing of the fixed income security by the seller;
enabling the seller to add the fixed income security to the seller's offerings;
enabling the seller to direct a description of the fixed income security and the sale terms to the attention of at least one second buyer via the computer communication network; and
enabling the at least one second buyer to view the description of the fixed income security and the sales terms via the computer communication network.

29. The method of claim 28, wherein the marketing by the seller is exclusive marketing.

30. The method of claim 28 and further comprising directing information to the first buyer about activities concerning the fixed income security via the computer communication network.

31. The method of claim 30, wherein the activities comprise bid activity or trade activity via the computer communication network.

32. The method of claim 28 and further comprising protecting against a failure to re-price the fixed income security in the event of market movement relating to the fixed income security.

33. The method of claim 32, wherein the fixed income security is priced based on a yield quoted as a difference from a yield curve benchmark and wherein the protecting comprises changing the sale terms in the event the yield curve benchmark changes.

34. A computer software application for the buyers and sellers to manage trading of fixed income securities, comprising a set of instructions that when executed by the computer system allows the buyers and sellers to perform the method of claim 28.
